(19) United States
(12) Patent Application Publication
(10) Pub. No.: US 2020/0265424 A1
(43) Pub. Date: Aug. 20, 2020

(54) METHOD FOR MANAGING POINTS

(71) Applicant: Woo CHOI, Seoul (KR)

(72) Inventor: Woo CHOI, Seoul (KR)

(21) Appl. No.: 16/500,366

(22) PCT Filed: Apr. 24, 2019
(86) PCT No.: PCT/KR2019/004941

§ 371 Date: Oct. 2, 2019

(30) Foreign Application Priority Data
Oct. 11, 2018 (KR) 10-2018-0121327

(51) Int. Cl. G06Q 20/38; G06Q 30/02

(52) U.S. Cl. CPC G06Q 20/387; G06Q 30/0283; G06Q 30/0226

(57) ABSTRACT

According to an exemplary embodiment of the present disclosure, a method of managing points is disclosed. Operations stored in a computer program for processing the method may include: receiving user information from at least one of a merchant server and a user terminal; receiving payment information and a point commission limit from the merchant server; receiving total point information including at least one of point information based on the user information, the amount of points held for each of the point information, and a point commission rate for each of the point information from each of one or more point servers; calculating a use point amount by payment point information that is at least a part of the total point information based on the point commission limit; and transmitting a payment request based on the use point amount by payment point information to each of the one or more point servers.

### TECHNICAL FIELD

The present invention relates to a method of managing points by using a computing device, and more particularly, to a solution for managing points based on a point commission limit.

### BACKGROUND ART

As the promotion for customers through the use and saving of the points became active by business operators, the number of customers joining points increased rapidly. The kind of point held per customer is also rapidly increasing.

In order for customers to use points for each business operator, there is a need to manage individual points. As the kinds of points held by the customers increase, there is a situation where the management of individual points is neglected and the use of the points is reduced. Accordingly, there is a demand for a method of effectively using points within a limit acceptable by customers who want to use points and each of the business operators.

Korean Patent No. 10-1894084 discloses a method of operating member points.

### SUMMARY OF THE INVENTION

The present disclosure is conceived in response to the background art, and has been made in an effort to provide a method of managing points.

According to an exemplary embodiment of the present disclosure for achieving the object, a computer program stored in a computer readable storage medium is disclosed. When the computer program is executed by one or more processors of a computing device, the computer program performs operations below for managing points, and the operations include: receiving user information from at least one of a merchant server and a user terminal; receiving payment information and a point commission limit from the merchant server; receiving total point information including at least one of point information based on the user information, the amount of points held for each of the point information, and a point commission rate for each of the point information from each of one or more point servers; calculating a use point amount by payment point information that is at least a part of the total point information based on the point commission limit; and transmitting a payment request based on the use point amount by payment point information to each of the one or more point servers.

In the alternative embodiment of the operations of the computer program for performing the operations for managing points, the point commission limit may include a limit of a total amount of point commission for the use of points to be paid to a point company set by the merchant.

In the alternative embodiment of the operations of the computer program for performing the operations for managing points, the calculating of the use point amount by payment point information that is at least a part of the total point information based on the point commission limit may include: determining a usage priority of each of the point information based on at least one of the point commission rate for each of the point information and information on the point server for each of the point information; and determining a use point amount by payment point information in the point information so that the total amount of point commission for each of the payment point information that is at least a part of the total point information is equal to or less than the point commission limit based on the usage priority, and the total amount of use points for each of the payment point information that is at least a part of the total point information is equal to or less than a product value included in the payment information based on the usage priority.

In the alternative embodiment of the operations of the computer program for performing the operations for managing points, the amount of point commission may be a value obtained by multiplying at least a part of the amount of points held for each of the point information and the point commission rate for each of the point information, and the amount of use points may be at least a part of the amount of points held based on the amount of point commission for each of the point information.

In the alternative embodiment of the operations of the computer program for performing the operations for managing points, the calculating of the use point amount by payment point information that is at least a part of the total point information based on the point commission limit may include: determining a usage priority of each of the point information based on a point commission rate for each of the point information for each of the point information; determining the amount of point commission of each of the point information based on the amount of points held and the point commission rate for each of the point information, and calculating the total amount of point commission of each of the point information; determining the entirety of the point information as usable point information when the total amount of point commission of each of the point information is equal to or less than the point commission limit; and determining at least a part of the point information as the usable point information when the total amount of point commission of each of the point information is larger than the point commission limit.

In the alternative embodiment of the operations of the computer program for performing the operations for managing points, the determining of at least a part of the point information as the usable point information when the total amount of point commission of each of the point information is larger than the point commission limit may include making an adjustment so that the total amount of point commission is equal to or less than the point commission limit by subtracting at least a part of the amount of point commission for the point information having a low priority among the usage priorities of the respective point information from the total amount of point commission.

In the alternative embodiment of the operations of the computer program for performing the operations for managing points, the operations may further include: calculating the total amount of use points for each of the usable point information; determining the usable point information as the payment point information when the total amount of use points for each of the usable point information is equal to or less than a product value included in the payment information; and determining at least a part of the usable point information as the payment point information when the total amount of use points for each of the usable point information is larger than the product value.

In the alternative embodiment of the operations of the computer program for performing the operations for managing points, the determining of at least a part of the usable point information as the payment point information may include making an adjustment so that the total amount of use points is equal to or less than the product value by subtracting at least a part of the amount of use points for the usable point information having a low priority among the usage priorities of the respective usable point information from the total amount of use points.

In the alternative embodiment of the operations of the computer program for performing the operations for managing points, the operations may further include: transmitting the amount of points based on the payment point information to at least one of a user terminal and the merchant server; receiving a use authorization for at least a part of the amount of points based on the payment point information from at least one of the user terminal and the merchant server; and calculating a use point amount by payment point information by adjusting the amount of points based on the payment point information on the basis of the use authorization and the usage priority.

In the alternative embodiment of the operations of the computer program for performing the operations for managing points, the operations may further include receiving at least one of a priority usable condition and an unusable condition for at least a part of the total point information from the user terminal, and the calculating of the use point amount by payment point information that is at least a part of the total point information based on the point commission limit may include: excluding the point information corresponding to the unusable condition from the payment point information;

determining the point information corresponding to the priority usable condition as the prior usage priority over the usage priority of each of the remaining point information, in which the point information corresponding to the priority usable condition is excluded from the total point information; and determining the usage priority of each of the point information based on the point commission rate for each of the point information for each of the point information except for at least one of the point information corresponding to the unusable condition and the point information corresponding to the priority usable condition in the total point information

In the alternative embodiment of the operations of the computer program for performing the operations for managing points, the operations may further include: receiving a point information use authority based on another user information from the user terminal; and receiving the amount of points held for each of the point information based on another user information and the point commission rate for each of the point information based on another user information from each of one or more point servers.

In the alternative embodiment of the operations of the computer program for performing the operations for managing points, the operations may further include receiving an alternative payment point information from the user terminal, and the calculating of the use point amount by payment point information in the point information based on the point commission limit may include determining the alternative payment point as the usage priority.

In the alternative embodiment of the operations of the computer program for performing the operations for managing points, the operations may further include: identifying at least one among restriction conditions for the point information included in at least one of the point information and the payment information; and excluding the point information identified based on the restriction condition in the total point information from the payment point information.

In the alternative embodiment of the operations of the computer program for performing the operations for managing points, the operations may further include, when one point server among the one or more point servers is the same as the merchant server, excluding the point information received from the same point server as the merchant server from the payment point information.

In the alternative embodiment of the operations of the computer program for performing the operations for managing points, the operations may further include: receiving restriction information on one point server among the one or more point servers from the merchant server; and excluding the point information received from the point server identified based on the restriction information from the payment point information.

In the alternative embodiment of the operations of the computer program for performing the operations for managing points, the operations may further include: receiving the total amount of points obtained by summing the amount of points held by each user from one point server among the one or more point servers; receiving deposit information on the point company based on the one point server from a bank server; and determining whether to exclude the point information received from the one point server from the payment point information based on the total amount of points, the deposit information, and a predetermined deposit rate.

In the alternative embodiment of the operations of the computer program for performing the operations for managing points, the operations may further include: receiving promotion point information including at least one of user information restriction, merchant information restriction, and purchase information restriction from at least one point server among the one or more point servers; and comparing the restriction included in the promotion point information with at least one of the user information, the merchant server, and the purchase information, and the operations may further include at least one of: matching the promotion point information to the user information based on the comparison and storing the matched promotion point information when a payment is completed; and determining the promotion point information as the highest priority among the usage priorities based on the comparison.

In the alternative embodiment of the operations of the computer program for performing the operations for managing points, the operations may further include:

calculating payment necessary information in which the use point amount by the payment point information is subtracted from the product value included in the payment information; transmitting at least a part of payable information, which is matched with the user information based on the payment necessary information and stored, to the merchant server; calculating finance server payment necessary information obtained by subtracting at least a part of the payable information transmitted to the merchant server from the payment necessary information; and transmitting the finance server payment necessary information to at least one finance server among one or more finance servers.

According to another exemplary embodiment of the present disclosure, a method of managing points is disclosed. The method may include: receiving user information, payment information, and a point commission limit from a merchant server; receiving total point information including at least one of point information based on the user information, the amount of points held for each of the point information, and a point commission rate for each of the point information from each of one or more point servers; calculating a use point amount by payment point information that is at least a part of the total point information based on the point commission limit; and transmitting a payment request based on the use point amount by payment point information to each of the one or more point servers.

According to another exemplary embodiment of the present disclosure, a computing device is disclosed. The computing device may include: a processor including one or more cores; and a memory, and the processor may receive user information, payment information, and a point commission limit from a merchant server, receive total point information including at least one of point information based on the user information, the amount of points held for each of the point information, and a point commission rate for each of the point information from each of one or more point servers, calculate a use point amount by payment point information that is at least a part of the total point information based on the point commission limit, and transmit a payment request based on the use point amount by payment point information to each of the one or more point servers.

The present disclosure may provide the method of managing points.

### BRIEF DESCRIPTION OF THE DRAWINGS

FIG. 1 is a block diagram illustrating a computing device performing an operation for managing points according to an exemplary embodiment of the present disclosure.

FIG. 2 is a diagram illustrating a system for managing points according to the exemplary embodiment of the present disclosure.

FIG. 3 is a block diagram illustrating a point management server performing an operation for managing points according to another exemplary embodiment of the present disclosure.

FIG. 4 is a diagram illustrating an example of a method of managing points based on a point commission limit according to the exemplary embodiment of the present disclosure.

FIG. 5 is a flowchart of the method of managing points according to the exemplary embodiment of the present disclosure.

FIG. 6 is a block diagram illustrating logic for implementing a method of managing points according to an exemplary embodiment of the present disclosure.

FIG. 7 is a block diagram illustrating a module for implementing a method of managing points according to an exemplary embodiment of the present disclosure.

FIG. 8 is a block diagram illustrating a circuit for implementing a method of managing points according to an exemplary embodiment of the present disclosure.

FIG. 9 is a block diagram illustrating a means for implementing a method of managing points according to an exemplary embodiment of the present disclosure.

FIG. 10 is a block diagram of a computing device according to an exemplary embodiment of the present disclosure.

### DETAILED DESCRIPTION

Hereinafter, various exemplary embodiments are described with reference to the drawings. In the present specification, various descriptions are presented for understanding the present disclosure. However, it is obvious that the exemplary embodiments may be carried out even without a particular description.

Terms, “component”, “module”, “system” and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and the computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as Internet, through data and/or a signal from one component interacting with another component in a local system and a distributed system) having one or more data packets.

A term “or” intends to mean comprehensive “or” not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

A term “include” and/or “including” shall be understood as meaning that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present invention. Various modifications of the exemplary embodiments will be apparent to those skilled in the art. General principles defined herein may be applied to other exemplary embodiments without departing from the scope of the present disclosure. Therefore, the present invention is not limited to the exemplary embodiments presented herein. The present invention shall be interpreted within the broadest meaning range consistent to the principles and new characteristics presented herein.

In an exemplary embodiment of the present disclosure, a server may also include other configurations for performing a server environment of the server. The server may include any type of device. The server is a digital device and may be a digital device, such as a laptop computer, a notebook computer, a desktop computer, a web pad, and a mobile phone, which is mounted with a processor, includes a memory, and has calculation ability. The server may be a web server processing a service. The foregoing kind of server is merely an example, and the present disclosure is not limited thereto.

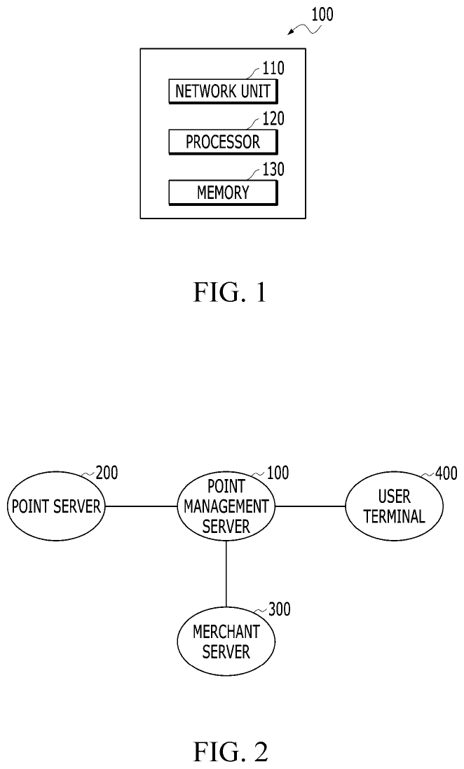

FIG. 1 is a block diagram illustrating a computing device performing an operation for managing points according to an exemplary embodiment of the present disclosure.

A configuration of a point management server 100 illustrated in FIG. 1 is a simplified example. In the exemplary embodiment of the present disclosure, the point management server 100 may include other configurations for performing a computing environment of the point management server 100.

The point management server 100 may include a network unit 110, a processor 120, and a memory 130. The computing device of the present disclosure may include a point management server of a point management platform.

A point according to the exemplary embodiment of the present disclosure may be a payment means having a cash value exchanged at a predetermined rate. For example, when a customer holds 1,000 points, the corresponding customer may use 1,000 points in exchange as cash of 1,000 won when purchasing a good, and or may use 1,000 points as cash of 100 won by exchanging the points and the cash at a different rate. The point may include a point and an alternative payment point based on point information. A particular method for a payment based on the alternative payment point will be described below. For example, the point based on the point information may be a point saved at a predetermined rate based on the purchase of an item (for example, save 450 points corresponding to 10% of 4,500 won when a customer pays 4,500 won for coffee in a coffee shop), a point saved in user information based on a promotion of a point server (for example, save 1,000 points usable on the day of the birthday for a user of the birthday or save 500,000 childbirth points to an employee who gave birth), a point usable only for a corresponding good when a customer purchases a specific good (for example, 80,000 point usable only when a customer purchases a newly released earphone), and a point related to a giftcon (for example, 1,200 points for a user to purchase banana milk that is a specific product of a point company purchased in a convenient store point company that is a point company based on a point server). A subject of issuing a point may be discriminated from a subject of using a point. For example, the subject of issuing the point may be a merchant server or a point server according to the exemplary embodiment of the present disclosure, and the subject of using the point may be a user of a user terminal according to the exemplary embodiment of the present disclosure. When the point management server 100 transfers point information to the merchant server, the point management server 100 may transfer the point information through the network unit 110 so that the point is recognized as a part of a payment means in the merchant server. The point may also be refunded to each user based on user information according to the setting of the point management server 100. For example, points forcibly set to be unusable by a country, points of a bankrupt point company based on a point server that is a subject of issuing the point, and the like may also be refunded to each user as cash. The particular description for the foregoing point is merely an example, and the present disclosure is not limited thereto.

The network unit 110 may transceive data and the like for performing the point management method according to the exemplary embodiment of the present disclosure with another computing device, a server, and the like. The network unit 110 may transceive data, such as user information, payment information, point commission limit information, and point information, required in the exemplary embodiment of the present disclosure with another computing device, a server, and the like. For example, the network unit 110 may receive at least one of user information, payment information, and point commission limit from the merchant server. Further, for example, the network unit 110 may receive total point information including at least one of point information based on the user information, the amount of points held for each of the point information, and a point commission rate for each of the point information from each of one or more point servers. Further, for example, the network unit 110 may receive alternative payment point information from the user terminal. The network unit 110 enables the plurality of computing devices to communicate each other to make each of the plurality of computing devices perform distributed processing of a calculation of a use point amount by payment point information based on the point commission limit.

The processor 120 may be formed of one or more cores, and may include a processor, such as a central processing unit (CPU), a general purpose graphics processing unit (GPGPU), and a tensor processing unit (TPU) of the computing device, for calculating the amount of use points and the like. The processor 120 may read a computer program stored in the memory 130 and perform the point management method according to the exemplary embodiment of the present disclosure. According to the exemplary embodiment of the present disclosure, the processor 120 may perform a calculation for managing points.

At least one of the CPU, the GPGPU, and the TPU of the processor 120 may process the calculation of a use point amount by payment point information for the management of the point and the like. For example, the CPU and the GPGPU may process the calculation of a use point amount by payment point information for the management of the point, a determination of usage priority of each of the point information, a calculation of a total amount of point commission, and the like together. Further, in the exemplary embodiment of the present disclosure, the processor 120 may process a restriction condition for point information on the point management, a calculation for an alternative payment point, and a use of points based on other user information, and the like by using the processors of the plurality of computing devices together. Further, the computer program executed in the computing device according to the exemplary embodiment of the present disclosure may be a CPU, GPGPU, or TPU executable program.

Hereinafter, an operation of receiving data from a merchant server according to the exemplary embodiment of the present disclosure will be described.

The processor 120 may receive user information, payment information, and a point commission limit from a merchant server through the network unit 110.

The merchant server may mean the server of a company which is capable of using points received from a point server of a point company in accordance with a setting condition of a user through the point management. For example, the merchant server may be a restaurant, a department store, a theater, a public office, and the like in which users want to use points. Each of the merchant servers may be identified based on merchant information. For example, the merchant information may also include a code, a name, and the like identifiable based on each merchant. The description for the foregoing merchant server is merely an example, and the present disclosure is not limited thereto.

The user information may mean information serving as a basis for identifying the point.

The user information according to the exemplary embodiment of the present disclosure may include information based on which a user who wants to use points is discriminated from other users. The user information may include different information for each merchant server. For example, the user information may include a name, a date of birth, an age, a mobile phone number, an address, an ID, a password, a nickname, a messenger ID, and the like. The detailed description for the foregoing user information is merely an example, and the present disclosure is not limited thereto.

The user information according to another exemplary embodiment of the present disclosure may mean an identifier for discriminating points. For example, the user information may include a coupon number, a membership number, a saving number, and a specific product purchase serial number. For example, all of the family members of customer A may share user information that is a membership number of customer A and use the points through the user information. For example, the point management server may receive user information including a serial number of a plum discount coupon which customer B receives after purchasing oranges at a mart, and receive point information based on the serial number of the plum discount coupon and the amount of points held from a server of the corresponding mart. For example, the point management server may receive a serial number of a gift certificate purchased offline as user information from a user terminal, and may also receive point information and a point commission rate from a server of a gift certificate based on a serial number of the gift certificate. The description for the foregoing user information is merely an example, and the present disclosure is not limited thereto.

The payment information may include information about an amount of money that a user may pay with points at a predetermined rate instead of the payment with cash. The payment information according to the exemplary embodiment of the present disclosure may include information on a good which a user wants to purchase at a merchant. The payment information according to another exemplary embodiment of the present disclosure may also include information which needs to be paid to the merchant. The payment information may include a product name and product value information on a good which a user wants to purchase at a merchant. The payment information may be changed according to goods which a user wants to purchase. The payment information may include information on an item for which a user needs to make a payment at the merchant.

The payment information may include product value information. In another exemplary embodiment, the payment information may be the amount of money obtained by subtracting point payments by at least one of affiliate's points and merchant's own points from the product value information. The processor 120 may determine a use point amount by payment point information so that a total amount of use points for each of the payment point information becomes the product value included in the payment information or less. In the exemplary embodiment, when there is no merchant's own point and merchant's affiliate's point, prices of a product sold in the merchant may be a product value included in the payment information. In another exemplary embodiment, when at least one of the merchant's own point and the merchant's affiliate's point is used in the merchant, the amount of money obtained by subtracting a point amount paid by at least one of the merchant's own point and the merchant's affiliate's point from the price of the product may be a product value included in the payment information. For example, in the case where merchant A sells a product worth 10,000 won to user B, a product value when there is no merchant A's own point and affiliate's point affiliated with merchant A, or there is no point amount held for user B in merchant A's own point server and a point server affiliated with merchant A may be 10,000 won. In the present example, the product value information included in the payment information received by the processor 120 through the network unit 110 may be 10,000 won. For another example, when merchant A sells a product worth 10,000 won to user B and the merchant A's own points of 2,000 won are used, a product value may be 8,000 won. In the present example, the product value information included in the payment information received by the processor 120 through the network unit 110 may be 8,000 won. In another exemplary embodiment, the payment information may also be information on a payment amount in which a promotion is applied to the product value information. The promotion may include discount information about a product value set in the merchant server. The promotion may be to reduce the product value itself, rather than to exchange points with cash value at a predetermined rate, unlike merchant's own point or merchant's affiliate's points. For example, when merchant A decides to promote a 10% discount on a product for customers purchasing a newly launched smart phone, the processor 120 may receive payment information corresponding to 1,260,000 won, which is obtained by applying the promotion of the 10% discount to 1,400,000 won that is a fixed price of the newly launched smart phone, from the merchant server through the network unit 110. In another exemplary embodiment, the payment information may be a payment amount obtained by subtracting points paid by at least one of merchant's own points and merchant's affiliate's points from a product value and applying a promotion. The product value information included in the payment information may be changed at each payment. The particular description for the foregoing payment information is merely an example, and the present disclosure is not limited thereto.

According to another exemplary embodiment of the present disclosure, the payment information may include information on an item for which a user needs to pay at a merchant, except for a product and services. The merchant according to another exemplary embodiment of the present disclosure may be an organization managing a facility or a product, not a place selling goods or services. The merchant according to the present exemplary embodiment may be a public office, a bank, and the like. The payment information may also include payment details according to a bill. For example, when a user pays maintenance fees, a merchant may be a management office of an apartment and payment information may be the amount of money based on the maintenance fees. For example, when a user pays a fine for illegal parking of a vehicle, the merchant may be a police office and the payment information may also be the amount of money based on a fine bill for illegal parking of a vehicle. For example, a user pays the comprehensive real estate holding tax, the merchant may be a national tax office and the payment information may also be the amount of money based on a payment bill for the comprehensive real estate holding tax. The particular description for the foregoing payment information is merely an example, and the present disclosure is not limited thereto.

According to another exemplary embodiment, the payment information may include merchant information. The merchant information may include information for discriminating one merchant from another merchant. The merchant information may be information related to a merchant identified based on a merchant server transmitting payment information.

The point commission limit may include a limit of a total amount of point commission for the use of points to be paid to a point company set by a merchant.

In the exemplary embodiment of the present disclosure, the point commission limit may include the amount of point commission for a product value that is a value obtained by multiplying the product value and a commission rate for the product value set in the merchant. For example, when merchant A sets a commission rate for a product value worth 10,000 won as 10%, a point commission limit that is a limit of a total amount of point commission which the merchant may pay to the point company may be 1,000 won that is (10,000 won)×(10%). For example, the commission rate for the product value may be changed according to a product, a user, or a payment case in the merchant. The description for the foregoing point commission limit is merely an example, and the present disclosure is not limited thereto.

In another exemplary embodiment of the present disclosure, when the payment information is the amount of money obtained by subtracting the point amount paid by at least one of the merchant's own points and the merchant's affiliate's points from a price of a product, the point commission limit may be a value obtained by subtracting at least one of the amount of affiliate's point commission and the amount of merchant point commission from the amount of point commission for the product value. The affiliate's points may be the points stored in the point server of the point company having a direct contract with the merchant. The point server based on the affiliate's points may be the same as one or more point servers connected with the point management server. The point server based on the affiliate's point may not be the same as one or more point servers connected with the point management server. The affiliate's point commission may be a value obtained by multiplying the amount of points held for each affiliate's point information and a point commission rate for each affiliate's point information. For example, when merchant A has a direct contact with company B to use the points of company B, the point information of company B may be affiliate's point information. For example, when the amount of points held by user C stored in a point server of company B is 2,000 won and a point commission rate of company B is 2%, the amount of affiliate's point commission may be 40 won. In the present exemplary embodiment, when the amount of point commission for the product value is 1,000 won, the point commission limit may be 960 won (1,000 won (the amount of point commission for the product value)−40 won (the amount of affiliate's point commission)). The merchant's points may be points for each user stored in the merchant server. The merchant's points may be points for each user stored in a memory of the merchant server. The amount of merchant's point commission may not have fee depending on a merchant. The amount of merchant's point commission may be a value obtained by multiplying the amount of points for each user stored in the merchant and a point commission rate. In the present exemplary embodiment, when the amount of points held by user C stored in the merchant server is 1,000 won and the point commission rate set by the merchant server is 10%, the amount of affiliate's point commission may be 100 won. In the present exemplary embodiment, when the amount of point commission for the product value is 1,000 won, the point commission limit may be 900 won (1,000 won (the amount of point commission for the product value)−100 won (the amount of merchant's point commission)). For another example, when user D spends all of the affiliate's points and the merchant's points, the point commission limit may be 860 won (1,000 won (the amount of point commission for the product value)−40 won (the amount of affiliate's point commission)−100 won (the amount of merchant point commission)). The description for the foregoing point commission limit is merely an example, and the present disclosure is not limited thereto.

In another exemplary embodiment of the present disclosure, when the payment information is information on the amount of payments to which the promotion is applied in a product value, the point commission limit may be a value obtained by subtracting the amount of commission based on the promotion from the amount of point commission for the product value. The amount of commission based on the promotion may mean the subtraction of at least a part of the amount of point commission for the product value according to the application of the discount information to the product value based on the discount information for the product value set by the merchant server. For example, when merchant A determines the promotion of 10% discount of a product for customers purchasing a newly launched smart phone, the payment information may be a 10% discount payment amount (in the present example, 1,260,000 won) of the product value (in this example, 1,400,000 won). In the present example, the commission limit may be the amount of money (in the present example, 70,000 points obtained by subtracting 50% of 140,000 points) obtained by subtracting the amount of commission based on the promotion from the amount of point commission for the product value (in the present example, 140,000 points that is 10% in the product value of 1,400,000 won) based on a predetermined rate (in the present example, 50%) set by merchant A to a user receiving the promotion. The description for the foregoing point commission limit is merely an example, and the present disclosure is not limited thereto.

In another exemplary embodiment of the present disclosure, when the payment information is the amount of payments obtained by subtracting points paid by at least one of the merchant's own points and the merchant's affiliate's points from a product value and applying the promotion, the point commission limit may be the commission limit obtained by subtracting the amount of commission based on the promotion from the value obtained by subtracting at least one of the amount of affiliate's point commission and the amount of merchant's point commission from the amount of point commission for the product value.

Hereinafter, an operation of receiving data from one or more point servers will be described.

The processor 120 may transmit information for requesting point information based on user information and information on the amount of points and a point commission rate to each of one or more point server through the network unit 110 based on the user information.

The processor 120 may receive the point information based on the user information and the information on the amount of points for each of the point information and the point commission rate for each of the point information from each of one or more point servers through the network unit 110. The point information may include information for discriminating the point operated by the point server from other points. The point information may be the information for discriminating points operated in one point server from points operated in another point server. The point information may also be the information for discriminating one point from another point among one or more points operated in one point server. The point information may include a name of the point held by the point server. The amount of points held for each of the point information may mean the amount of points held matched with the user information and the point information stored in the point server. The point commission rate for each of the point information may mean the commission rate to be transferred to the point company, which is the commission rate set by the point company.

For example, the processor 120 may receive B point (that is, the point information) of user A based on user information on user A, 1,000 points (that is, the amount of points held for each of the point information) that is the points held for B point of user A, and 5% (that is, the point commission rate for each point information) that is the point commission rate for B point of user A from the point server through the network unit 110. The description for the point information, the amount of points held, and the point commission rate received from the point server is merely an example, and the present disclosure is not limited thereto.

Hereinafter, an operation of calculating the amount of use points based on data received from the merchant server and the point server will be described.

The processor 120 may calculate a use point amount by payment point information that is at least a part of the total point information based on the point commission limit.

The processor 120 may determine a usage priority of each of the point information based on at least one of the point commission rate for each of the point information and the information on the point server for each of the point information. The point commission rate for each of the point information may mean the commission rate to be transferred to the point company set by the point company. The information on the point server may include information on a criterion for identifying the point server from another point server and determining a usage priority. The information on the point server may include at least one of evaluation information for the point company identified based on the point server and information on the amount of use points of the point information identified based on the point server. The processor 120 may determine that in the point commission rate for each of the point information, as the commission rate is lower, a usage priority is higher. The processor 120 may determine that in the information on the point server, as the evaluation information on the point company is higher, a usage priority is higher. The processor 120 may determine that as the amount of use points of the point information identified based on the point server in the information on the point server is larger, a usage priority is higher. The processor 120 may determine a usage priority by setting a weight to the point commission rate and the information on the point server. The weight may be a value which the point management server may determine. The processor 120 may determine a usage priority based on a total obtained by multiplying the point commission rate and the information on the point server and weight values, respectively, and summing the two values.

For example, when the processor 120 determines a usage priority of each of the point information based on the point commission rate for each of the point information, and a point commission rate for point information a received from point server A is 3%, a point commission rate for point information b received from point server B is 15%, and a point commission rate for point information c received from point server C is 10%, the processor 120 may determine that the point information having the smallest commission rate has a high usage priority, and determine the usage priority in order of point information a, point information c, and point information b. For another example, when the processor 120 determines a usage priority of each of the point information based on the information on the point server, and the amount of use points based on point information an on point server A is 10,000 points, the amount of use points based on point information b on point server B is 3,000 points, and the amount of use points based on point information c on point server C is 17,000 points, the processor 120 may determine that as the amount of use points of the point information identified based on the point server in the information on the point server is larger, a usage priority is higher, and determine the usage priority in order of point information c, point information a, and point information b.

The processor 120 may determine a total amount of point commission for each of the payment point information that is at least a part of the total point information to be equal to or less than a point commission limit based on the usage priority. The amount of point commission may be a value obtained by multiplying at least a part of the amount of points held for each of the point information and the point commission rate for each of the point information. The processor 120 may determine the total amount of use points for each of the payment point information that is at least a part of the total point information to be equal to or less than a product value included in the payment information based on the usage priority. The amount of use points may be at least a part of the amount of points held based on the amount of point commission for each of the point information. The processor 120 may determine the use point amount by payment point information in the point information so that the total amount of point commission is equal to or less than the point commission limit and the total amount of use points is equal to or less than a product value included in the payment information.

The processor 120 may determine a usage priority of each of the point information based on the point commission rate of each of the point information for each of the point information. The processor 120 may determine the amount of point commission of each of the point information based on the amount of points held and a point commission rate for each of the point information. The amount of point commission may be the amount of money obtained by multiplying the amount of points held and the point commission rate for each of the point information. The processor 120 may calculate the total amount of point commission of each of the point information. The total amount of point commission may be the value obtained by summing the amount of point commission of each of the point information. When the total amount of point commission for each of the point information is equal to or less than the point commission limit, the processor 120 may determine the entirety of the point information as usable point information. The usable point information may include the point information, which makes the total amount of point commission be equal to or less than the point commission limit, in the point information. When the total amount of point commission for each of the point information exceeds the point commission limit, the processor 120 may determine at least a part of the point information as the usable point information. The operation of determining, by the processor 120, at least a part of the point information as the usable point information may be the operation of subtracting at least a part of the amount of point commission for the point information having the low usage priority among the usage priorities of the point information from the total amount of point commission and making an adjustment so that the total amount of point commission is equal to or less than the point commission limit.

The operation of determining the usable point information will be described with an example. For example, the processor 120 may receive user information on user A, 10,000 that is the product value information included in the payment information, and 1,000 won that is the point commission limit from the merchant server through the network unit 110. For example, the processor 120 may receive point information a, the amount of points held of 2,000, and the point commission rate of 3% from point server A, point information b, the amount of points held of 15,000, and the point commission rate of 5% from point server B, and point information c, the amount of points held of 6,000, and the point commission rate of 10% from point server C through the network unit 110. For example, the processor 120 may determine priorities of the point information as a, b, and c based on a point commission rate for each of the point information. For example, the processor 120 may determine the amount of point commission of each of the point information as 60 won for a, 750 won for b, and 600 won for c by multiplying the amount of points held and the point commission rate for each of the point information. For example, the processor 120 may calculate a total amount of point commission as 1,410 won by summing the amount of point commission of each of the point information. For example, the calculated total amount of point commission is 1,410 won, so that the processor 120 may determine that the total amount of point commission exceeds 1,000 won that is the point commission limit. For example, the processor 120 may adjust the total amount of point commission for the usable point information to be equal to or less than the point commission limit by subtracting at least a part of the amount of point commission for point information c having the lower usage priority in the point information from the total amount of point commission. For example, the processor 120 may adjust the total amount of point commission for the usable point information to be equal to or less than 1,000 won that is the point commission limit by subtracting 410 won that is the amount of point commission for point information c from the total amount of point commission. For example, the processor 120 may determine the amount of point commission of 60 won for point information a, the amount of point commission of 750 won for point information b, and the amount of point commission of 190 won for point information c as the usable point information. The description for the foregoing operation of determining the usable point information is merely an example, and the present disclosure is not limited thereto.

In another exemplary embodiment, the processor 120 may determine, for each of the point information, a usage priority of each of the point information based on a point commission rate for each of the point information. The processor 120 may calculate so that the total amount of point commission is equal to or less than the point commission limit by summing the point information having the high usage priority based on the usage priority. The processor 120 may determine the point information on the amount of point commission configuring the total amount of point commission determined based on the usage priority as the usable point information.

The operation of determining the usable point information will be described based on another example. In the foregoing example, when the priorities of the point information are a, b, and c, the processor 120 may calculate the total amount of point commission to be equal to or less than the point commission limit (in the present example, 1,000 won) by summing the amount of point commission of 60 won for point information a, the amount of point commission of 750 won for point information b, and the amount of point commission of 190 won for point information c. For example, the processor 120 may determine the usable point information with the part of point information a, point information b, and point information c. The description for the foregoing operation of determining the usable point information is merely an example, and the present disclosure is not limited thereto.

The processor 120 may calculate the amount of use points for each of the usable point information. The processor 120 may calculate the total amount of use points by summing each of the amounts of use points. The processor 120 may compare the total amount of use points for each of the usable point information with the product value. When the total amount of use points for each of the usable point information is equal to or less than the product value included in the payment information, the processor 120 may determine the usable point information as the payment point information. The payment point information may include point information, which makes the total amount of point commission be equal to or less than the point commission limit and the total amount of use points be equal to or less than the product value, in the point information. When the total amount of use points for each of the usable point information exceeds the product value, the processor 120 may determine at least a part of the usable point information as the payment point information. The operation of determining, by the processor 120, at least a part of the usable point information as the payment point information may be the operation of making an adjustment so that the total amount of use points is equal to or less than the product value by subtracting at least a part of the amount of use points for the usable point information having the low usage priority among the usage priorities of the usable point information from the total amount of use points.

The operation of determining the payment point information will be described based on an example. In the foregoing example, the processor 120 may determine the payment point information based on the determination of the amount of point commission of 60 won for point information a as 60 won, the amount of point commission of 750 won for point information b, and the amount of point commission of 190 won for point information c as the usable point information. The processor 120 may calculate the use points for each of the usable point information. For example, the processor 120 may calculate the amount of use points for point information a as 2,000 won (in the present example, 60 won×(100/3)), the amount of use points for point information b as 15,000 won (in the present example, 750 won×(100/5)), and the amount of use points for point information c as 1,900 won (in the present example, 190 won×(100/10)) by calculating the amount of use points for each of the usable point information. For example, the processor 120 may calculate the total amount of use points as 18,900 won by summing the amount of use points for each of the usable point information. For example, the processor 120 may determine that the total amount of use points of 18,900 won exceeds the product value of 10,000 won. For example, the processor 120 may make an adjustment so that the total amount of use points is equal to or less than the product value (in the present example, 10,000 won) by subtracting (in the present example, subtracting 8,900 won) at least a part of the amount of use points for the usable point information having the low priority (subtracting in order of point information c, b, and a) from the total amount of use points (in the present example, 18,900 won). For example, the processor 120 may subtract the amount of points for point information c of 1,900 won and the amount of points for point information b of 7,000 won, which are at least parts of the amounts of use points for the usable point information having the low usage priorities, from the total amount of use points of 18,900 won. For example, the processor 120 may determine the parts of point information a and point information b as the payment point information. The description of the foregoing operation of determining the payment point information is merely an example, and the present disclosure is not limited thereto.

In another exemplary embodiment, the processor 120 may calculate the total amount of use points to be equal to or less than the product value by summing the point information having the high usage priority based on the usage priority. The processor 120 may determine the point information of the amount of use points configuring the total amount of use points determined based on the usage priority as the payment point information.

The operation of determining the payment point information will be described based on another example. In the foregoing example, when the usage priorities of the point information are a, b, and c, the processor 120 may calculate the total amount of use points to be equal to or less than the product value (in the present example, 10,000 won) by summing the amount of use points for point information a of 2,000 won and the amount of use points for point information b of 8,000 won. For example, the processor 120 may determine the payment point information with the parts of point information a and point information b. The description for the foregoing operation of determining the usable point information is merely an example, and the present disclosure is not limited thereto.

The processor 120 may transmit the amount of points based on the payment point information to at least one of the user terminal and the merchant server through the network unit 110. The processor 120 may receive a use authorization for at least a part of the amount of points based on the payment point information from at least one of the user terminal and the merchant server through the network unit 110. When the received use authorization is the entirety of the amount of points based on the payment point information, the processor 120 may determine the amount of points based on the payment point information as the amount of use points. When the received use authorization is a part of the amount of points based on the payment point information, the processor 120 may calculate the use point amount by payment point information by adjusting the amount of points based on the payment point information on the basis of the use authorization and the usage priority. The processor 120 may make an adjustment so that the use point amount by payment point information is equal to or less than the amount of points included in the received use authorization by subtracting at least a part of the amount of points for the point information having the low priority from the amount of points based on the payment point information. In the foregoing example, the processor 120 may determine the amount of use points for point information a of 2,000 won and the amount of use points for point information b of 8,000 won as the amount of points based on the payment point information. For example, the processor 120 may transmit the amount of use points for point information a of 2,000 won and the amount of use points for point information b of 8,000 won to the user terminal. For example, the processor 120 may receive the use authorization for 6,000 won in the amount of points based on the payment point information from the user terminal. For example, the processor 120 may make an adjustment so that the amount of use points is equal to or less than the points included in the use authorization by subtracting 4,000 won that is a part of the amount of points of 8,000 won for point information b having the low priority from the amount of points (in the present example, 10,000 won) based on the payment point information on the basis of the use authorization. For example, the processor 120 may determine the amount of use points for point information a of 2,000 won and the amount of use points for point information b of 4,000 won as the amount of use points for each of the payment point information. The description for the foregoing operation of calculating the use point amount by payment point information based on the use authorization is merely an example, and the present disclosure is not limited thereto.

The processor 120 may transmit a payment request based on the use point amount by payment point information to each of one or more point servers through the network unit 110. The processor 120 may receive the amount of money excluding the amount of point commission from the use point amount by payment point information from each of one or more point servers through the network unit 110. The processor 120 may transmit the amount of money excluding the amount of point commission from the use point amount by payment point information to the merchant server through the network unit 110.

Hereinafter, an operation of calculating points based on a priority usable condition and an unusable condition for the point information received from the user terminal will be described.

The processor 120 may receive at least one of a priority usable condition and an unusable condition for at least a part of the total point information from the user terminal through the network unit 110. The priority usable condition may mean the condition for preferentially using corresponding point information over other point information. The unusable condition may mean the condition for excluding the points corresponding to the condition in the point information from use. For the point information based on the priority usable condition, the processor 120 may assign the highest priority among the use priorities to the corresponding point information before setting the use priority of each of the point information based on at least one of the point commission rate for each of the point information and the information on the point server. For the point information based on the unusable condition, the processor 120 may exclude the corresponding point information from the use priority before setting the use priority of each of the point information based on at least one of the point commission rate for each of the point information and the information on the point server. The processor 120 may exclude the point information corresponding to the unusable condition from the payment point information. The processor 120 may determine the point information corresponding to the priority usable condition as the prior usage priority over the usage priority of each of the remaining point information, in which the point information corresponding to the priority usable condition is excluded from the total point information. For each of the point information except for at least one of the point information corresponding to the unusable condition and the point information corresponding to the priority usable condition in the total point information, the processor 120 may determine the usage priority of each of the point information based on the point commission rate for each of the point information.

For example, when the point commission rate for point information a received from point server A through the network unit 110 is 3%, the point commission rate for point information b received from point server B is 15%, the point commission rate for point information c received from point server C is 10%, and the point commission rate for point information d received from point server D is 8%, and the processor 120 receives the priority usable condition of point information c and the unusable condition of point information a from the user terminal, the processor 120 may determine the usage priorities for the point information in order of point information c, d, and b. The description for the foregoing operation of determining the priority based on the condition received from the user terminal is merely an example, and the present disclosure is not limited thereto.

Hereinafter, the contents for the sharing and the use of the points by a plurality of users will be described.

The processor 120 may receive a point information use authority based on another user information from the user terminal through the network unit 110. The point information use authority based on another user information may mean authentication information in which point information based on another user information is includable as the payment point information together with the user own point information. When the processor 120 receives the user information from the merchant server and transmits the received user information to one or more point servers through the network unit 110, the processor 120 may transmit another user information to one or more point servers together with the user information. The processor 120 may receive point information, the amount of points held for each of the point information based on the user information and another user information, and a point commission rate for each of the point information from each of the one or more point servers through the network unit 110. For example, the user information and a unique code for each user may be matched and stored in the memory 130, and the unique code may be transmitted only to the matched user terminal through the network unit 110. For example, when the processor 120 receives information on another user B and a unique code for user B from the terminal of user A through the network unit 110, the processor 120 may match the information on user A and the information on user B and store the matched information in the memory 130 so that user A is allowed to use the points held by user B. When the processor 120 receives the information on user A from the merchant through the network unit 110, the processor 120 may transmit both the information on user A and the information on user B to one or more point servers, and receive the total point information on user A and the total point information on user B from the one or more point servers. The disclosure of the foregoing sharing and use of the points is merely an example, and the present disclosure is not limited thereto.

In another exemplary embodiment, the processor 120 may receive sharing point request information for using the point information based on another user information from the user terminal through the network unit 110. The processor 120 may transmit the user information based on the user terminal and information indicating whether the sharing point request is accepted to another user terminal identified based on the sharing point request information through the network unit 110. When the processor 120 receives the information in which the sharing point request is accepted from another user terminal through the network unit 110, the processor 120 may match the user information and another user information and store the matched information in the memory 130. The processor 120 may receive total point information including at least one of point information, the amount of points held for each of the point information, a point commission rate for each of the point information based on another user information from each of one or more point servers through the network unit 110. For example, when the processor 120 receives the sharing point request information based on the information on user B from the terminal of user A through the network unit 110, the processor 120 may transmit the information on user A and the information in which the sharing point request is accepted to the terminal of user B. For example, when the processor 120 receives the information indicating that the sharing point request is accepted from the terminal of user B through the network unit 110, the processor 120 may match the information on user A and the information on user B and store the matched information in the memory 130. When the processor 120 receives the information on user A from the merchant through the network unit 110, the processor 120 may transmit both the information on user A and the information on user B to one or more point servers, and receive the total point information on user A and the total point information on user B from the one or more point servers. The disclosure of the foregoing sharing and use of the points is merely an example, and the present disclosure is not limited thereto.

Hereinafter, a point payment method using alternative payment point information will be described.

The processor 120 may receive the alternative payment point information from the user terminal through the network unit 110. The alternative payment point information may include points other than points based on the point information among the points for paying the product value. The alternative payment point information may mean the points which need to be preferentially used compared to the points based on the point information. For example, the alternative payment point information may include a gift certificate, a giftcon, a discount coupon, and a prior-use saved money. Before the processor 120 receives the user information from the merchant server through the network unit 110, the alternative payment point information may not be stored in the memory 130. After the processor 120 receives the user information from the merchant server through the network unit 110, the alternative payment point information may be stored in the memory 130. The processor 120 may transmit the user information and alternative payment points to an alternative payment means server identified based on the alternative payment point information through the network unit 110. The processor 120 may receive at least one of a point commission rate and the amount of point commission for the alternative payment means from the alternative payment means server through the network unit 110. The processor 120 may determine the alternative payment point information as the highest priority among the usage priorities. The processor 120 may determine the alternative payment point information as the highest priority in the usage priorities over the usage priority determined based on at least one of the point commission rate for each of the point information and the information on the point server. For example, the processor 120 may receive gift certificate payment means information (in the present example, the information on the gift certificate of 10,000 won) that is the alternative payment point information from the user terminal of user A through the network unit 110. The processor 120 may transmit the information on user A and the gift certificate payment means information to a gift certificate server identified based on the gift certificate payment means information through the network unit 110. The processor 120 may receive at least one of the point commission rate (in the present example, 30%) for the gift certificate payment means information and the amount of point commission (in the present example, 10,000 won×30%=3,000 won) from the gift certificate server through the network unit 110. The processor 120 may set the gift certificate payment means information as the usage priority. When the point commission rate for another point information is less than 30%, the processor 120 may determine the gift certificate payment means information as the highest priority in the usage priorities. The description for the foregoing alternative point information is merely an example, and the present disclosure is not limited thereto.

According to another exemplary embodiment, the processor 120 may receive information for purchasing the alternative payment point information from the user terminal through the network unit 110. The information for purchasing the alternative payment point information may include information for purchasing the alternative payment point through an alternative payment point selling server on the basis of the point information received from one or more point servers. For example, the processor 120 may receive information (that is, the alternative payment point information) for purchasing a gift certificate of 100,000 won, which a gift certificate selling server of a department store (that is, the alternative payment point selling server) sells, from the user terminal through the network unit 110. For the purchase of the alternative payment point information through point information based on user information received from each of one or more point servers, the processor 120 may transmit point information corresponding to a value of the alternative payment point information to the alternative payment point selling server and receive the alternative payment point information from the alternative payment point selling server through the network unit 110. For example, in order to purchase a gift certificate of 100,000 won, the processor 120 may transmit 100,000 points in the point information based on the user information received from server A to a gift certificate selling server of a department store (that is, the alternative payment point selling server) and may also receive information on the gift certificate of 100,000 won (that is, the alternative payment point information) from the gift certificate selling server of the department store (that is, the alternative payment point selling server) through the network unit 110. The particular description for the foregoing alternative payment point information is merely an example, and the present disclosure is not limited thereto.

Hereinafter, a point payment method according to a point limit condition will be described.

The processor 120 may identify at least one among restriction conditions for the point information included in at least one of the point information and the payment information. The restriction condition may include a condition under which the points are usable. The restriction condition may include at least one of a condition regarding a target of use of the point and a condition regarding the degree of use of the point. The condition regarding a target of use of the point may include conditions for a subject and an item for which the point is used. The condition regarding a target of use of the point may include conditions for a country, an industry, a store type, a store, a business operator, an article, and the like in which the point is usable. The condition regarding the degree of use of the point may include a condition restricting use of at least a part of the points. The restriction condition may be expressed based on a code for identification. The processor 120 may assign an identification code to each of one or more merchant's servers, and assign an identification code to each of one or more point servers. The merchant information may be an identification code assigned to the merchant server. When at least one of the merchant server and the point server joins the point management server, the processor 120 may assign identification codes to the merchant server and the point server, respectively, and store the identification codes in the memory 130. The processor 120 may identify restriction conditions based on the code for each of the country, the industry, the store type, the store, the business operator, and the kind of item and the code for the degree of use of the points stored in the memory 130, and determine whether the restriction condition is satisfied. When at least one of the restriction condition included in the point information and the restriction conditions included in the payment information is not satisfied, the processor 120 may exclude the point information from the payment point information. In the exemplary embodiment, the processor 120 may identify the restriction condition for the point information included in the payment information. The processor 120 may calculate a use point amount by payment point information only for the point information satisfying the restriction condition for the point information included in the payment information. The processor 120 may exclude the points which do not satisfy the restriction condition for the point information included in the payment information from the calculation of the use point amount by payment point information or from the payment point information.

For example, the restriction condition may include a setting code. For example, the first digit of the setting code that is the restriction condition may be a country, the second digit may be an industry, the third digit may be a store type, the fourth digit may be a store, the fifth digit may be an item, and the sixth digit may be the degree of use of the point. For example, the setting code for each country may be 1 for Korea, 2 for Japan, 3 for USA, the setting code for each industry may be 1 for a distribution, 2 for a restaurant business, and the like, the setting code for each kind of store may be 1 for a café, 2 for a restaurant, and the like, the setting code for each store may be 1 for coffee store A, 2 for coffee store B, and the like, the setting code for each item may be 1 for Americano, 2 for latte, and the like, and the setting code for each degree of use of the point may be 1 for 100% usable of points, 2 for only 50% usable of points, and the like, and when the setting code is 0, there may be no condition. For example, the processor 120 may determine whether to include or exclude the point information according to a sign indicated in the setting code digit. For example, in the case of (+), it may be possible to use the points only when the corresponding code is satisfied, and in the case of (−), it may be possible to use the points only when the corresponding code is not satisfied. For example, when point server A saves the points for the customers, who purchase Americano, for free as a promotion for the merchants, the restriction condition for the point information of the corresponding free point may be set to 0, 0, +1, 0, +1. For example, the processor 120 may identify the restriction condition 0, 0, +1, 0, +1 included in the point information, and check whether the restriction condition 0, 0, +1, 0, +1 is matched with the information (in the present example, the case where the customer purchases shaved ice at a café) included in the payment information. For example, when the restriction condition included in the point information is not matched with the information included in the payment information and the merchant information identified based on the merchant server, the processor 120 may exclude the point information from the payment point information. For example, in the case where points saved in other chicken restaurants cannot be used at a merchant selling chickens, the restriction condition included in the payment information may be 0, 0, 0, 0, −4. The description for the foregoing restriction condition is merely an example, and the present disclosure is not limited thereto.

According to the exemplary embodiment of the present disclosure, the point information received from each of one or more point servers may include the restriction condition. In the restriction condition included in the point information received from point server A, a country providing range may be set to 0. In the restriction condition included in the point information received from point server B, a country providing range may be set to +3 (in the present example, the restriction condition in which the point is usable only in the USA). When the processor 120 receives the user information and the payment information from a hotel server of Korea, a country restriction code assigned to the merchant server that is the hotel server of Korea is 1, so that the point information received from point server A may be included for the calculation, but the point information received from point server B is usable only in USA, so that point information B received from point server B may be excluded from the payment point information.

The point management server 100 may be managed for each country. The point management server 100 may transceive data with point servers of a corresponding country. The point management server 100 of each country may transceive data related to the point. The point management server 100 of one country does not transceive data with point servers of other countries, but point management servers of other countries receive all of the data from the point server of the corresponding country, so that the point management server 100 of one country may transceive data with the point management servers of other countries. For example, the point management server of Korean may not transceive data with an individual point server of USA. For example, the point management server of USA possessing information on an individual point server of USA and the point management server of Korea may transceive data. The particular description for the foregoing point management server is merely an example, and the present disclosure is not limited thereto.

According to another exemplary embodiment of the present disclosure, when the restriction condition included in the point information includes a code indicating that only 50% of the points is usable, it is impossible to use the points corresponding to 50% of the point information, so that the point information may be excluded from the payment point information.

According to another exemplary embodiment of the present disclosure, the point information received from a welfare point server of Gyeonggi-do among the point servers may include the restriction condition in which a point providing range is set to Gyeonggi-do. The processor 120 may compare the condition of the merchant server and the restriction condition of the point information, and when the merchant server includes a code condition corresponding to Seoul, the point information may be excluded from the payment point information.

According to another exemplary embodiment of the present disclosure, the point information received by the processor 120 from tour point server A, tour point server B, and tour point server C may include the restriction condition for “(−) hotel”. The point management server 100 of Korea may store the point information in the memory 130, and transmit the point information to a point management server of Japan through the network unit 110. The point management server of Japan may provide a merchant server except for a hotel merchant server of Japan with the point information of tour point server A, tour point server B, and tour point server C.

The particular description for the foregoing point restriction condition is merely an example, and the present disclosure is not limited thereto.

Hereinafter, a method of preventing double use in the case where merchant's own points are used will be described.

When one point server among the one or more point servers is the same as the merchant server, the processor 120 may exclude the point information received from the same point server as the merchant server from the payment information. For example, when there are merchant's own points a at merchant A and the processor 120 has the point information received from the server of merchant A among the point management servers, the processor 120 may exclude the point information received from the server of merchant A from the payment point information. In the case where there are merchant's points which are autonomously saved and used by the merchant, the merchant's points may be used in the server of the corresponding merchant, so that even though the merchant is connected with the point management server and is operated as the point server, when the point information received from the point server is included in the calculation in the point management server, a problem may be generated. Accordingly, the double point calculation may be prevented by excluding the point information received from the same point server as the merchant server from the payment point information.

Hereinafter, a method of preventing double use of affiliate's points when there are affiliate's points directly affiliated with the merchant server will be described.

The processor 120 may receive restriction information on one point server among the one or more point servers from the merchant server through the network unit 110. The restriction information on the point server may include information for excluding the point information received from at least a part of one or more point servers from the payment information. The restriction information on the point server may include information on an affiliate point server communicating with the merchant server. The processor 120 may exclude the point information received from the point server identified based on the restriction information from the payment point information. In the case where there are affiliate's points directly affiliated with the merchant, the affiliate's points may be used in the server of the corresponding merchant, so that even though the affiliate point server is connected with the point management server and is operated as the point server, when the point information received from the point server is included in the calculation in the point management server, a problem may be generated. Accordingly, the dual point operation may be prevented by excluding the point information received from the affiliate point server which directly transmits or receives the point information with the merchant server from the payment point information.

Hereinafter, a method of calculating points according to a deposit will be described.

The processor 120 may receive the total amount of points obtained by summing the amount of points held by each user from one point server among the one or more point servers through the network unit 110. The processor 120 may receive deposit information on the point company based on the one point server from a bank server through the network unit 110. The bank server may include a server providing financial services in which banking and deposit related work are available. The deposit information for the point company may be information on a deposited amount of the point company matched with the information on the point company stored in a memory of the bank server. The processor 120 may determine whether to exclude the point information received from the one point server from the payment point information based on the total amount of points, the deposit information, and the predetermined deposit rate.

For example, when the total amount of saved money held by the point company is 10,000,000 points, the actual amount of money deposited in a bank by the point company is 4,000,000 won, and a deposit rate determined by the point management server 100 is 30%, the point information received from the point server of the point company may be included in the calculation of the use point amount by payment point information. For example, when the total amount of saved money held by the point company is 10,000,000 points, the actual amount of money deposited in a bank by the point company is 2,000,000 won, and a deposit rate determined by the point management server 100 is 30%, the point information received from the point server of the point company may be excluded from the calculation of the use point amount by payment point information or excluded from the payment point information. The description for the foregoing point calculation based on the deposit is merely an example, and the present disclosure is not limited thereto.

Hereinafter, a method of calculating promotion points will be described.

The processor 120 may receive promotion point information including at least one of user information restriction, merchant information restriction, and purchased-product restriction from at least one point server among the one or more point servers through the network unit 110. The promotion point information may be information about the points provided to the user based on a predetermined restriction condition, not the points stored based on the user information among the points. The promotion point information may be usable points for a corresponding payment. The promotion point information may be points which may be matched with the user information and stored when the corresponding payment is completed. For example, a promotion point received from a point server of a cider manufacturing company may include, when a customer purchases three bundles of cider (that is, the purchase information restriction) at E-mart (that is, the merchant information restriction), points for providing 1,000 points for the corresponding payment. For example, a promotion point received from a point server of a jacket manufacturing company may include, when a customer purchases jackets of 300,000 won or more made by the jacket manufacturing company (that is, the purchase information restriction) at a department store (that is, the merchant information restriction), points for providing 5,000 points usable at Starbucks. The description for the foregoing promotion point is merely an example, and the present disclosure is not limited thereto.

The promotion point information may include one or more restriction conditions. The restriction condition may include a condition for at least one of the user information restriction, the merchant information restriction, and the purchase information restriction. The user information restriction may mean to provide the promotion point information only to a specific user or to provide the promotion point information only to the remaining users except for a specific user. For example, the promotion point information may include the user information restriction in which the promotion point information is provided only to the users of 20's. The merchant information restriction may mean to provide the promotion point information only to a predetermined merchant among the merchants identified based on the merchant server or only to merchants except for a predetermined merchant. For example, the promotion point information may include the merchant information restriction information in which the point information is determined to be usable only at the Shinsaegae Department Store. The purchased-product restriction may mean to provide the promotion point information only when users pay for a specific product. For example, the promotion point information may include the purchased-product restriction in which it is determined to provide the point when a customer purchases a newly launched smart phone.

The processor 120 may compare a restriction included in the promotion point information with at least one of the user information, the merchant server, and the purchased product. According to the exemplary embodiment of the present disclosure, when the restriction condition included in the promotion point information is satisfied, payment completion information is received from the merchant server through the network unit 110, and the payment is completed, the processor 120 may match the promotion point information to the user information and store the matched promotion point information in the memory 130. The promotion point information stored in the memory 130 may be transmitted to another point server. In the foregoing example, in the case where the promotion point is the points regarding the provision of 5,000 points usable at Starbucks when a customer purchases the jacket costing 300,000 won or more made by the jacket manufacturing company (that is, the purchase information restriction) at the department store (that is, the merchant information restriction), and information indicating that the corresponding payment is completed is received from the department store server, the promotion point information regarding 5,000 points for Starbucks may be matched to the user information and stored in the memory 130. The processor 120 may transmit the information regarding 5,000 points which is matched to the user information and stored in the memory 130 to a Starbucks point server through the network unit 110 so that the information is managed by the Starbucks point server. The processor 120 may determine the promotion point information as the highest priority among the usage priorities in the case where the restriction condition included in the promotion point information is satisfied. The processor 120 may allow the promotion point to be used by setting the promotion point information to a prior priority over other point information. The processor 120 may transmit information indicating whether to use the promotion point information to at least one of the user terminal and the merchant server through the network unit 110. When the processor 120 receives the information indicating that the promotion point information is used from at least one of the user terminal and the merchant server through the network unit 110, the processor 120 may match the promotion point information to the user information and store the promotion point information in the memory 130 or determine the promotion point information as the highest priority among the usage priorities. The description for the foregoing promotion point is merely an example, and the present disclosure is not limited thereto.

For example, the processor 120 may receive the promotion point information from a Fendi server among the one or more point servers through the network unit 110. The promotion point information received from the Fendi server may include the merchant information restriction (in the present example, the point is provided only when a customer purchases a product at the Galleria Department Store) and the purchased-product restriction (in the present example, the point is provided only when a customer purchases a Peekaboo bag). The promotion point information may include information indicating that it is possible to use the point information only for a corresponding payment for purchasing the Peekaboo bag at the Galleria Department Store. Otherwise, the promotion point information may also include information indicating that Starbucks points are saved for a user purchasing the Peekaboo bag at the Galleria Department Store. The promotion point information may not be the point stored in the Fendi server that is the point server based on the user information. When the point management server receives the promotion point information from the Fendi server through the network unit 110, the processor 120 determines whether the restriction condition is satisfied. When the processor 120 receives purchased-product information regarding the purchase of the Peekaboo bag from the Galleria merchant server through the network unit 110, the processor 120 may determine that the promotion point information satisfies the restriction condition for the corresponding payment. When the promotion point information includes the information indicating that it is possible to use the point information only for the corresponding payment for purchasing the Peekaboo bag at the Galleria Department Store, the processor 120 may determine the promotion point information as the highest priority among the usage priorities. When the promotion point information includes the information indicating that Starbucks points are saved for the user purchasing the Peekaboo bag at the Galleria Department Store and the network unit 110 receives payment completion information from the Galleria server, the processor 120 may determine that the payment is completed, and match the promotion point information for Starbucks point with the user information and store the promotion point information in the memory 130 based on the user information. The processor 120 may transmit the promotion point information stored in the memory 130 to the Starbucks point server through the network unit 110. The particular description for the foregoing promotion point is merely an example, and the present disclosure is not limited thereto.

According to the exemplary embodiment of the present disclosure, the promotion point information may be discriminated from the point information. The processor 120 may determine only the promotion point information as the payment point information or determine only the point information as the payment point information according to a selection for the promotion point information or the point information received from the merchant server. The processor 120 may also determine both the promotion point information and the point information as the payment point information. The processor 120 may calculate a limit for at least a part of a point commission limit on the basis of the promotion point information and calculate a limit for the remaining part of the point commission limit on the basis of the point information, based on the setting information on the point commission limit received from the merchant server. For example, according to the setting information received from the merchant server, the processor 120 may calculate 600 won in the point commission limit of 1,000 won based on the promotion point information and calculate remaining 400 won in the point commission limit of 1,000 won based on the point information. When the total amount of payment point commission calculated based on the promotion point information is less than the point commission limit, the processor 120 may also calculate a limit obtained by subtracting the total amount of payment point commission from the point commission limit based on the point information as the payment point information again. When the total amount of payment point commission calculated based on the point information is less than the point commission limit, the processor 120 may also calculate a limit obtained by subtracting the total amount of payment point commission from the point commission limit based on the promotion point information as the payment point information again. For example, in the calculation of 600 won in the point commission limit of 1,000 won based on the promotion point information according to the setting information received from the merchant server, when the total amount of payment point commission in the promotion point information is 250 won, 350 won that is the remaining limit amount obtained by subtracting 250 won from 600 won may be calculated based on the point information, so that the commission limit corresponding to a total of 750 won may also be calculated based on the point information. The particular description for the foregoing point commission limit is merely an example, and the present disclosure is not limited thereto.

Hereinafter, a method of paying the amount of money excluding the point information from the product value will be described.

The processor 120 may calculate payment necessary information in which the use point amount by the payment point information is subtracted from the product value included in the payment information. The payment necessary information may be the information in which the use point amount by the payment point information is subtracted from the product value. The payment necessary information may be the information regarding the amount of money which needs to be paid with cash, not with points. For example, when an actual product value is 100,000 won and the use point amount calculated based on the point information is 20,000 won, the payment necessary information may be 80,000 won. The particular description for the foregoing payment necessary information is merely an example, and the present disclosure is not limited thereto.

The processor 120 may transmit at least a part of payable information, which is matched with the user information based on the payment necessary information and stored, to the merchant server through the network unit 110. The payable information which is matched with the user information and stored may mean the amount of cash which is received from a finance server and is matched with the user information and is stored in the point management server 100. For example, the point management server 100 may receive the amount of money authenticated through the user terminal through an authentication process with the user terminal based on the user information from the Kookmin Bank server. For example, the point management server 100 may match the payable information corresponding to 20,000 won received from the Kookmin Bank server with the user information and store the payable information. The processor 120 may transmit amount information corresponding to 50,000 won stored in the payable information in the amount of 80,000 won included in the payment necessary information to the merchant server through the network unit 110. The processor 120 may receive use-on information or use-off information for the payment necessary information from the user terminal through the network unit 110. When the processor 120 receives the use-off information for the payment necessary information from the user terminal, even though there is the payment necessary information matched with the user information and stored in the memory 130, the processor 120 cannot transmit at least a part of the payable information to the merchant server based on the payment necessary information. Only when the processor 120 receives the use-on information for the payment necessary information from the user terminal, the processor 120 may perform the operation of transmitting at least a part of the payable information to the merchant server. The description for the foregoing payable information is merely an example, and the present disclosure is not limited thereto. That is, according to the present exemplary embodiment, the point management server itself sets a point management server pay to enable users to store the amounts in the point management server pay and make payments through the point management server pay.

The processor 120 may calculate finance server payment necessary information obtained by subtracting at least a part of the payable information transmitted to the merchant server from the payment necessary information. The finance server payment necessary information may be the amount obtained by subtracting at least a part of the payable information transmitted to the merchant server from the payment necessary information. The finance server payment necessary information may include information on the amount to be paid through the finance server. For example, when the payment necessary information is 80,000 won and the information stored in the payable information is 50,000 won, the finance server payment necessary information may be 30,000 won that is the amount obtained by subtracting 50,000 won from 80,000 won. The processor 120 may determine the finance server payment necessary information corresponding to 30,000 won.

The processor 120 may transmit the finance server payment necessary information to at least one finance server among the one or more finance servers through the network unit 110. The finance server may be the server of an agency managing cash of the user. The finance server may be a bank server and a platform server in which cash may be stored. For example, the bank server may be the Kookmin Bank server and the Hana Bank server. For example, the platform server may be the Kakao Pay server, the Naver Pay server, and the Samsung Pay server. According to the exemplary embodiment of the present disclosure, the processor 120 may receive amount information based on the finance server payment necessary information from the finance server. According to another exemplary embodiment of the present disclosure, the finance server may directly transmit amount information based on the finance server payment necessary information to the merchant server without passing the point management server 100.

The processor 120 may receive on or off information for one or more finance servers from the user terminal. When the processor 120 receives the off information for a specific finance server from the user terminal, the processor 120 may not transmit the amount information based on the payment necessary information to the finance server based on the off information.

The processor 120 may receive priority information on one or more finance servers from the user terminal. The processor 120 may preferentially transmit the amount information based on the payment necessary information to a finance server having a high priority based on the priority information. For example, in the case where the priority information for the finance server is the Kakao Pay No. 1, the Naver Pay No. 2, and the Kookmin card No. 3, the processor 120 may transmit the payment necessary information to the Kakao Pay finance server and pay the amount based on the payment necessary information on the basis of the amount stored in Kakao Pay, and when the amount stored in Kakao Pay is less than the amount based on the payment necessary information, the processor 120 may transmit the remaining payment necessary information to the Naver Pay finance server that is the next ranking.

The particular description for the foregoing finance server is merely an example, and the present disclosure is not limited thereto.

The operation in the case where the total amount of point commission is larger than or equal to or less than the point commission limit described according to the exemplary embodiment of the present disclosure may be interpreted as the operation in the case where the total amount of point commission is equal to or larger than, or is less than the point commission limit, the total amount of point commission is larger than or is less than the point commission limit, and the total amount of point commission is equal to or larger than or is equal to or less than the point commission limit.

The operation in the case where the total amount of use points is larger than or is equal to or less than the product value described according to the exemplary embodiment of the present disclosure may be interpreted as the operation in the case where the total amount of use points is equal to or larger than, or is less than the product value, the total amount of use points is larger than or is less than the product value, and the total amount of use points is equal to or larger than, or is equal to or less than the product value.

The memory 130 may store a computer program for performing the point management method according to the exemplary embodiment of the present disclosure, and the stored computer program may be read and driven by the processor 120.

The memory 130 according to the exemplary embodiments of the present disclosure may store a program for the operation of the processor 120, and may temporarily or permanently store input/output data (for example, the user information, the payment information, the point commission limit, and the total point information). The memory 130 may store data related to a display and a sound. The memory 130 may include at least one type of storage medium among a flash memory type, a hard disk type, a multimedia card micro type, and the card type of memory (for example, an SD or XD memory), a Random Access Memory (RAM), a Static Random Access Memory (SRAM), a Read-Only Memory (ROM), an Electrically Erasable Programmable Read-only Memory (EEPROM), a Programmable Read-Only Memory (PROM), a magnetic memory, a magnetic disk, and an optical disk.

FIG. 2 is a diagram illustrating a system for managing points according to the exemplary embodiment of the present disclosure.

The point management server 100 may transmit or receive data with the point server, 200, the merchant server 300, and the user terminal 400.

The point management server 100 may calculate a use point amount by payment point information that is at least a part of the total point information based on a point commission limit. The point management server 100 may determine a usage priority of each of the point information based on at least one of a point commission rate for each of the point information and information on the point server for each of the point information. The point management server 100 may determine the use point amount by payment point information in the point information so that the total amount of point commission for each of the payment point information that is at least a part of the total point information is equal to or less than the point commission limit based on the usage priority, and the total amount of use points for each of the payment point information that is at least a part of the total point information is equal to or less than a product value included in the payment information based on the usage priority.

The point management server 100 may determine the amount of point commission of each of the point information based on the amount of points held and the point commission rate for each of the point information, and calculate the total amount of point commission of each of the point information. When the total amount of point commission of each of the point information is equal to or less than the point commission limit, the point management server 100 may determine the entirety of the point information as usable point information. When the total amount of point commission of each of the point information is larger than the point commission limit, the point management server 100 may determine at least a part of the point information as the usable point information. The point management server 100 may make an adjustment so that the total amount of point commission is equal to or less than the point commission limit by subtracting at least a part of the amount of point commission for the point information having a low priority among the usage priorities of the respective point information from the total amount of point commission.

The point management server 100 may calculate the total amount of use points for each of the usable point information. When the total amount of use points for each of the usable point information is equal to or less than a product value included in the payment information, the point management server 100 may determine the usable point information as the payment point information. When the total amount of use points for each of the usable point information is larger than the product value, the point management server 100 may determine at least a part of the usable point information as the payment point information. The point management server 100 may make an adjustment so that the total amount of use points is equal to or less than the product value by subtracting at least a part of the amount of use points for the usable point information having a low priority among the usage priorities of the respective usable point information from the total amount of use points.

The point server 200 may transmit the total point information including at least one of point information, the amount of points held for each of the point information, and a point commission rate for each of the point information to the point management server 100 based on the user information.

The merchant server 300 may transmit the user information, the payment information, and point commission limit information to the point management server 100.

The user terminal 40 may transmit use authorization for at least a part of the amount of points based on the payment point information, a priority usable condition and an unusable condition for at least a part of the total point information, and a point information use authority based on another user information to the point management server 100.

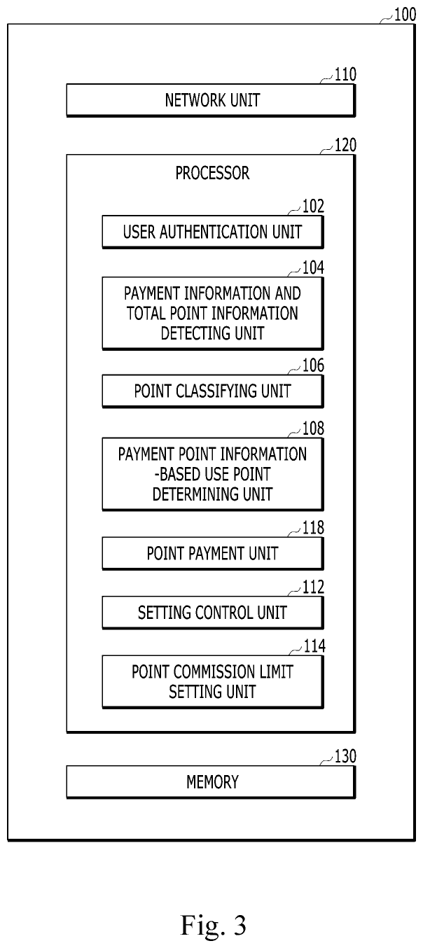

FIG. 3 is a block diagram illustrating a point management server performing an operation for managing points according to another exemplary embodiment of the present disclosure.

A user authentication unit 102 may check whether there is matched information in user information stored in a memory 130 based on user information received from a merchant server.

A payment information and total point information detecting unit 104 may store the user information, payment information, and a point commission limit received from the merchant server in the memory 130. The payment information and total point information detecting unit 104 may store total point information including at least one of point information based on the user information, the amount of points held for each of the point information, and a point commission rate for each of the point information received from each of one or more point servers in the memory 130.

A point classifying unit 106 may classify the amount of points held and the point commission rate received from each of the one or more point servers based on the point information and store the classified amount of points held and point commission rate in the memory 130.

A payment point information-based use point determining unit 108 may calculate a use point amount by payment point information that is at least a part of the total point information based on the point commission limit. The payment point information-based use point determining unit 108 may determine a usage priority of each of the point information based on at least one of the point commission rate for each of the point information and information on the point server for each of the point information. The payment point information-based use point determining unit 108 may determine the use point amount by payment point information in the point information so that the total amount of point commission for each of the payment point information that is at least a part of the total point information is equal to or less than the point commission limit based on the usage priority, and the total amount of use points for each of the payment point information that is at least a part of the total point information is equal to or less than a product value included in the payment information based on the usage priority.

A point payment unit 118 may transmit a payment request based on the use point amount by payment point information to each of the one or more point servers.

A setting control unit 112 may receive at least one of a priority usable condition and an unusable condition for at least a part of the total point information from a user terminal. The setting control unit 112 may exclude the point information corresponding to the unusable condition from the payment point information. The setting control unit 112 may determine the point information corresponding to the priority usable condition as a prior usage priority over a usage priority of each of the remaining point information except for the point information corresponding to the priority usable condition in the total point information. The setting control unit 112 may identify at least one of restriction conditions for the point information included in at least one of the point information and the payment information. The setting control unit 112 may exclude the point information identified based on the restriction condition in the total point information from payment point information. When one point server among the one or more point servers is the same as the merchant server, the setting control unit 112 may exclude the point information received from the same point server as the merchant server from the payment point information. When the setting control unit 112 receives restriction information about one point server among the one or more point servers from the merchant server, the setting control unit 112 may exclude the point information received from the point server identified based on the restriction information from the payment point information.

A point commission limit setting unit 114 may store a point commission limit received from the user terminal in the memory 130.

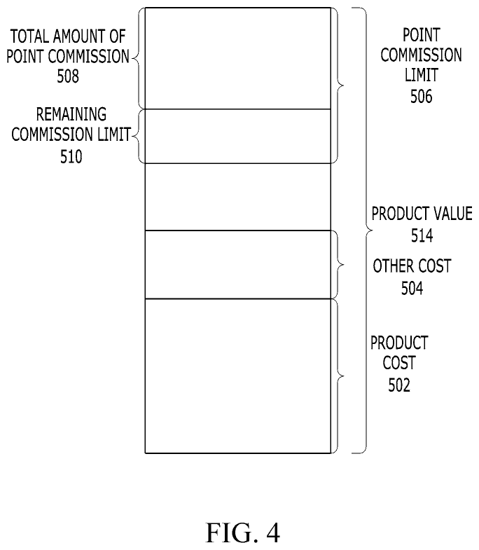

FIG. 4 is a diagram illustrating an example of a method of managing points based on a point commission limit according to the exemplary embodiment of the present disclosure.

The point management server 100 may calculate a total amount 508 of point commission based on a point commission limit 506 and a product value 514 received from a merchant server. The point commission limit 506 may be the limit of the amount of point commission paid to a point company set by a merchant for a product. The product value 514 may be a payment price set by the merchant for a product. The total amount 508 of point commission may include a sum of the amounts of point commission to be paid to the point company set based on the product value 514 and the point commission limit 506.

When the total amount 508 of point commission is equal to or less than the point commission limit 506, a difference may be a remaining commission limit 510. The remaining commission limit 510 may be shared within one or more point information and allocated for using the points based on another point information. One or more point information may include at least one of point information based on user information, promotion point information, alternative payment point information, and point information corresponding to a priority usable condition. For example, the point management server 100 may determine payment point information in accordance with the point commission limit by using only the point information based on the user information, and when there is the remaining commission limit 510, the point management server 100 may additionally determine the payment point information in accordance with the remaining commission limit 510 by using the promotion point information. That is, the point management server 100 may calculate the total amount 508 of point commission based on one point information (in the present example, the point information based on the user information), and when there is the remaining point commission limit 510, the point management server 100 may determine the payment point information by additionally calculating the payment point information in accordance with the point commission limit by using the promotion point information based on another point information (in the present example, the promotion point information). The point management server 100 may transmit information on the remaining commission limit 510 to the merchant server.

From the merchant's point of view, the product value 514 may be a value including other cost 504 and product cost 502. Accordingly, the merchant may set the point commission limit 506 to be equal to or less than a value obtained by subtracting other cost 504 and the product cost 502 from the product value 514. The amount obtained by excluding the total amount 508 of point commission, other cost 504, and the product cost 502 from the product value 514 may be an actual margin of the merchant.

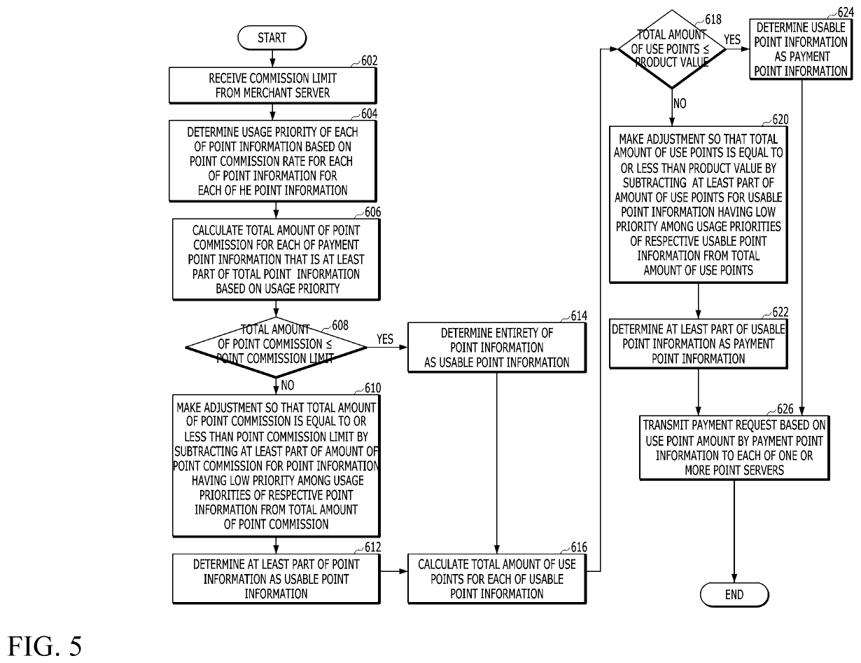

FIG. 5 is a flowchart of the method of managing points according to the exemplary embodiment of the present disclosure.

The point management server 100 may receive user information, payment information, and a point commission limit from a merchant server (602). The user information may include information based on which a user who wants to use points is discriminated from other users. The payment information may include information on a good which a user wants to purchase at a merchant. The payment information may include a product name and product value information on a good which a user wants to purchase at a merchant. The point commission limit may include a limit of a total amount of point commission for the use of points to be paid to a point company set by a merchant.

The point management server 100 may receive total point information including at least one of point information based on the user information, the amount of points held for each of the point information, and a point commission rate for each of the point information from each of one or more point servers. The point information may include information for discriminating the point operated by the point server from other points. The amount of points held for each of the point information may mean the amount of points held matched with the user information and the point information stored in the point server. The point commission rate for each of the point information may mean a commission rate to be transferred to a point company set by the point company.

The point management server 100 may determine a usage priority of each of the point information based on at least one of the point commission rate for each of the point information and the information on the point server for each of the point information (604). The point management server 100 may determine that in the point commission rate for each of the point information, as the commission rate is lower, a usage priority is higher.

The point management server 100 may calculate the total amount of point commission for each of the payment point information that is at least a part of the total point information based on the usage priority (606). The point commission may be a value obtained by multiplying at least a part of the amount of points held for each of the point information and the point commission rate for each of the point information.

The point management server 100 may determine whether the total amount of point commission is equal to or less than the point commission limit (608).

When the total amount of point commission is equal to or less than the point commission limit, the point management server 100 may determine the entirety of the point information as usable point information (614). The usable point information may include the point information, which makes the total amount of point commission be equal to or less than the point commission limit, in the point information.

When the total amount of point commission is equal to or less than the point commission limit, the point management server 100 may make an adjustment so that the total amount of point commission is equal to or less than the point commission limit by subtracting at least a part of the amount of point commission for the point information having a low priority among the usage priorities of the respective point information from the total amount of point commission (610). The point management server 100 may determine at least a part of the point information as usable point information (612).

The point management server 100 may calculate the total amount of use points for each of the usable point information (616).

The point management server 100 may determine whether the total amount of use points is equal to or less than a product value (618).

When the total amount of use points for each of the usable point information is equal to or less than a product value included in the payment information, the point management server 100 may determine the usable point information as the payment point information (624).

When the total amount of use points for each of the usable point information is larger than the product value, the point management server 100 may make an adjustment so that the total amount of use points is equal to or less than the product value by subtracting at least a part of the amount of use points for the usable point information having a low priority among the usage priorities of the respective usable point information from the total amount of use points (620). The point management server 100 may determine at least a part of the usable point information as the payment point information (622).

The point management server 100 may transmit a payment request based on the use point amount by payment point information to each of the one or more point servers (626).

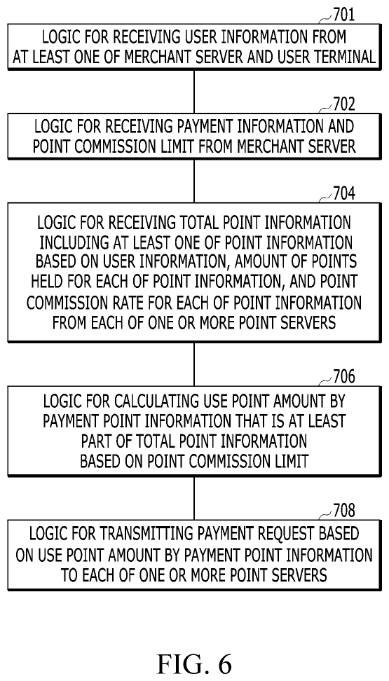

FIG. 6 is a block diagram illustrating logic for implementing a method of managing points according to an exemplary embodiment of the present disclosure.

According to an exemplary embodiment of the present disclosure, a method of managing points may be implemented by logic described below.

According to the exemplary embodiment of the present disclosure, the method of managing points may be implemented by: logic 701 for receiving user information from at least one of a merchant server and a user terminal; logic 702 for receiving payment information and a point commission limit from the merchant server; logic 704 for receiving total point information including at least one of point information based on the user information, the amount of points held for each of the point information, and a point commission rate for each of the point information from each of one or more point servers; logic 706 for calculating a use point amount by payment point information that is at least a part of the total point information based on the point commission limit; and logic 708 for transmitting a payment request based on the use point amount by payment point information to each of the one or more point servers.

In the alternative embodiment of the method of managing points, the logic 706 for calculating the use point amount by payment point information that is at least a part of the total point information based on the point commission limit may also be implemented by: logic for determining a usage priority of each of the point information based on at least one of the point commission rate for each of the point information and information on the point server for each of the point information; and logic for determining a use point amount by payment point information in the point information so that the total amount of point commission for each of the payment point information that is at least a part of the total point information is equal to or less than the point commission limit based on the usage priority, and the total amount of use points for each of the payment point information that is at least a part of the total point information is equal to or less than a product value included in the payment information based on the usage priority.

In the alternative embodiment of the method of managing points, the logic 706 for calculating the use point amount by payment point information that is at least a part of the total point information based on the point commission limit may also be implemented by: logic for determining a usage priority of each of the point information based on a point commission rate for each of the point information for each of the point information; logic for determining the amount of point commission of each of the point information based on the amount of points held and the point commission rate for each of the point information, and calculating the total amount of point commission of each of the point information; logic for determining the entirety of the point information as usable point information when the total amount of point commission of each of the point information is equal to or less than the point commission limit; and logic for determining at least a part of the point information as the usable point information when the total amount of point commission of each of the point information is larger than the point commission limit.

In the alternative embodiment of the method of managing points, the logic for determining at least a part of the point information as the usable point information when the total amount of point commission of each of the point information is larger than the point commission limit may also be implemented by logic for making an adjustment so that the total amount of point commission is equal to or less than the point commission limit by subtracting at least a part of the amount of point commission for the point information having a low priority among the usage priorities of the respective point information from the total amount of point commission.

In the alternative embodiment of the method of managing points, the method may also be additionally implemented by: logic for calculating the total amount of use points for each of the usable point information; logic for determining the usable point information as the payment point information when the total amount of use points for each of the usable point information is equal to or less than a product value included in the payment information; and logic for determining at least a part of the usable point information as the payment point information when the total amount of use points for each of the usable point information is larger than the product value.

In the alternative embodiment of the method of managing points, the logic for determining at least a part of the usable point information as the payment point information may also be implemented by logic for making an adjustment so that the total amount of use points is equal to or less than the product value by subtracting at least a part of the amount of use points for the usable point information having a low priority among the usage priorities of the respective usable point information from the total amount of use points.

In the alternative embodiment of the method of managing points, the method may also be additionally implemented by: logic for transmitting the amount of points based on the payment point information to at least one of a user terminal and the merchant server; logic for receiving a use authorization for at least a part of the amount of points based on the payment point information from at least one of the user terminal and the merchant server; and logic for calculating a use point amount by payment point information by adjusting the amount of points based on the payment point information on the basis of the use authorization and the usage priority.

In the alternative embodiment of the method of managing points, the method may also be additionally implemented by logic for receiving at least one of a priority usable condition and an unusable condition for at least a part of the total point information from the user terminal, and the logic 706 for calculating the use point amount by payment point information that is at least a part of the total point information based on the point commission limit may also be implemented by: logic for excluding the point information corresponding to the unusable condition from the payment point information; logic for determining the point information corresponding to the priority usable condition as the prior usage priority over the usage priority of each of the remaining point information, in which the point information corresponding to the priority usable condition is excluded from the total point information; and logic for determining the usage priority of each of the point information based on the point commission rate for each of the point information for each of the point information except for at least one of the point information corresponding to the unusable condition and the point information corresponding to the priority usable condition in the total point information.

In the alternative embodiment of the method of managing points, the method may also be additionally implemented by: logic for receiving a point information use authority based on another user information from the user terminal; and logic for receiving the amount of points held for each of the point information based on another user information and the point commission rate for each of the point information based on another user information from each of one or more point servers.

In the alternative embodiment of the method of managing points, the method may also be additionally implemented by logic for receiving an alternative payment point from the user terminal, and the logic 706 for calculating the use point amount by payment point information in the point information based on the point commission limit may also be implemented by logic for determining the alternative payment point as the usage priority.

In the alternative embodiment of the method of managing points, the method may also be additionally implemented by: logic for identifying at least one among restriction conditions for the point information included in at least one of the point information and the payment information; and logic for excluding the point information identified based on the restriction condition in the total point information from the payment point information.

In the alternative embodiment of the method of managing points, the method may also be additionally implemented by logic for, when one point server among the one or more point servers is the same as the merchant server, excluding the point information received from the same point server as the merchant server from the payment point information.

In the alternative embodiment of the method of managing points, the method may also be additionally implemented by: logic for receiving restriction information on one point server among the one or more point servers from the merchant server; and logic for excluding the point information received from the point server identified based on the restriction information from the payment point information.

In the alternative embodiment of the method of managing points, the method may further include: logic for receiving promotion point information including at least one of user information restriction, merchant information restriction, and purchase information restriction from at least one point server among the one or more point servers;

and logic for comparing the restriction included in the promotion point information with at least one of the user information, the merchant server, and the purchase information, and the method may also be implemented by at least one of logic for matching the promotion point information to the user information based on the comparison and storing the matched promotion point information when a payment is completed; and logic for determining the promotion point information as the highest priority among the usage priorities based on the comparison.

In the alternative embodiment of the method of managing points, the method may also be additionally implemented by: logic for calculating payment necessary information in which the use point amount by the payment point information is subtracted from the product value included in the payment information; logic for transmitting at least a part of payable information, which is matched with the user information based on the payment necessary information and stored, to the merchant server; logic for calculating finance server payment necessary information obtained by subtracting at least a part of the payable information transmitted to the merchant server from the payment necessary information; and logic for transmitting the finance server payment necessary information to at least one finance server among one or more finance servers.

In the alternative embodiment of the method of managing points, the method may also be additionally implemented by: logic for receiving the total amount of points obtained by summing the amount of points held by each user from one point server among the one or more point servers; logic for receiving deposit information on the point company based on the one point server from a bank server; and logic for determining whether to exclude the point information received from the one point server from the payment point information based on the total amount of points, the deposit information, and a predetermined deposit rate.

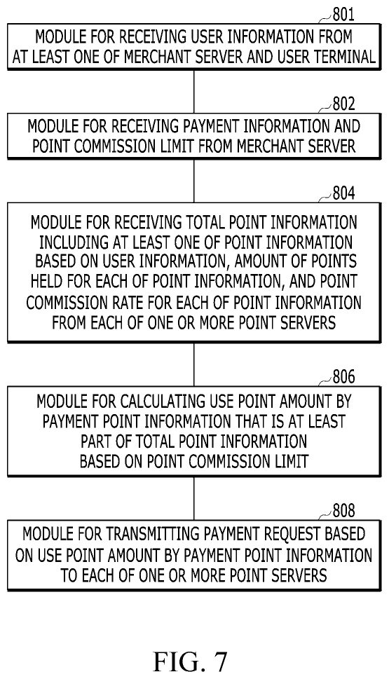

FIG. 7 is a block diagram illustrating a module for implementing a method of managing points according to an exemplary embodiment of the present disclosure.

According to an exemplary embodiment of the present disclosure, a method of managing points may be implemented by modules described below.

According to the exemplary embodiment of the present disclosure, the method of managing points may be implemented by: a module 801 for receiving user information from at least one of a merchant server and a user terminal; a module 802 for receiving payment information and a point commission limit from the merchant server; a module 804 for receiving total point information including at least one of point information based on the user information, the amount of points held for each of the point information, and a point commission rate for each of the point information from each of one or more point servers; a module 806 for calculating a use point amount by payment point information that is at least a part of the total point information based on the point commission limit; and a module 808 for transmitting a payment request based on the use point amount by payment point information to each of the one or more point servers.

In the alternative embodiment of the method of managing points, the module 806 for calculating the use point amount by payment point information that is at least a part of the total point information based on the point commission limit may also be implemented by: a module for determining a usage priority of each of the point information based on at least one of the point commission rate for each of the point information and information on the point server for each of the point information; and a module for determining a use point amount by payment point information in the point information so that the total amount of point commission for each of the payment point information that is at least a part of the total point information is equal to or less than the point commission limit based on the usage priority, and the total amount of use points for each of the payment point information that is at least a part of the total point information is equal to or less than a product value included in the payment information based on the usage priority.

In the alternative embodiment of the method of managing points, the module 806 for calculating the use point amount by payment point information that is at least a part of the total point information based on the point commission limit may also be implemented by: a module for determining a usage priority of each of the point information based on a point commission rate for each of the point information for each of the point information; a module for determining the amount of point commission of each of the point information based on the amount of points held and the point commission rate for each of the point information, and calculating the total amount of point commission of each of the point information; a module for determining the entirety of the point information as usable point information when the total amount of point commission of each of the point information is equal to or less than the point commission limit; and a module for determining at least a part of the point information as the usable point information when the total amount of point commission of each of the point information is larger than the point commission limit.

In the alternative embodiment of the method of managing points, the module for determining at least a part of the point information as the usable point information when the total amount of point commission of each of the point information is larger than the point commission limit may also be implemented by a module for making an adjustment so that the total amount of point commission is equal to or less than the point commission limit by subtracting at least a part of the amount of point commission for the point information having a low priority among the usage priorities of the respective point information from the total amount of point commission.

In the alternative embodiment of the method of managing points, the method may also be additionally implemented by: a module for calculating the total amount of use points for each of the usable point information; a module for determining the usable point information as the payment point information when the total amount of use points for each of the usable point information is equal to or less than a product value included in the payment information; and a module for determining at least a part of the usable point information as the payment point information when the total amount of use points for each of the usable point information is larger than the product value.

In the alternative embodiment of the method of managing points, the module for determining at least a part of the usable point information as the payment point information may also be implemented by a module for making an adjustment so that the total amount of use points is equal to or less than the product value by subtracting at least a part of the amount of use points for the usable point information having a low priority among the usage priorities of the respective usable point information from the total amount of use points.

In the alternative embodiment of the method of managing points, the method may also be additionally implemented by: a module for transmitting the amount of points based on the payment point information to at least one of a user terminal and the merchant server; a module for receiving a use authorization for at least a part of the amount of points based on the payment point information from at least one of the user terminal and the merchant server; and a module for calculating a use point amount by payment point information by adjusting the amount of points based on the payment point information on the basis of the use authorization and the usage priority.

In the alternative embodiment of the method of managing points, the method may also be additionally implemented by a module for receiving at least one of a priority usable condition and an unusable condition for at least a part of the total point information from the user terminal, and the module 806 for calculating the use point amount by payment point information that is at least a part of the total point information based on the point commission limit may also be implemented by: a module for excluding the point information corresponding to the unusable condition from the payment point information; a module for determining the point information corresponding to the priority usable condition as the prior usage priority over the usage priority of each of the remaining point information, in which the point information corresponding to the priority usable condition is excluded from the total point information; and a module for determining the usage priority of each of the point information based on the point commission rate for each of the point information for each of the point information except for at least one of the point information corresponding to the unusable condition and the point information corresponding to the priority usable condition in the total point information.

In the alternative embodiment of the method of managing points, the method may also be additionally implemented by: a module for receiving a point information use authority based on another user information from the user terminal; and a module for receiving the amount of points held for each of the point information based on another user information and the point commission rate for each of the point information based on another user information from each of one or more point servers.

In the alternative embodiment of the method of managing points, the method may also be additionally implemented by a module for receiving an alternative payment point from the user terminal, and the module 806 for calculating the use point amount by payment point information in the point information based on the point commission limit may also be implemented by the module for determining the alternative payment point as the usage priority.

In the alternative embodiment of the method of managing points, the method may also be additionally implemented by: a module for identifying at least one among restriction conditions for the point information included in at least one of the point information and the payment information; and a module for excluding the point information identified based on the restriction condition in the total point information from the payment point information.

In the alternative embodiment of the method of managing points, the method may also be additionally implemented by a module for, when one point server among the one or more point servers is the same as the merchant server, excluding the point information received from the same point server as the merchant server from the payment point information.

In the alternative embodiment of the method of managing points, the method may also be additionally implemented by: a module for receiving restriction information on one point server among the one or more point servers from the merchant server; and a module for excluding the point information received from the point server identified based on the restriction information from the payment point information.

In the alternative embodiment of the method of managing points, the method may also be additionally implemented by: a module for receiving restriction information on one point server among the one or more point servers from the merchant server; and a module for excluding the point information received from the point server identified based on the restriction information from the payment point information.

In the alternative embodiment of the method of managing points, the method may further include: a module for receiving promotion point information including at least one of user information restriction, merchant information restriction, and purchase information restriction from at least one point server among the one or more point servers; and a module for comparing the restriction included in the promotion point information with at least one of the user information, the merchant server, and the purchase information, and the method may also be implemented by at least one of a module for matching the promotion point information to the user information based on the comparison and storing the matched promotion point information when a payment is completed; and a module for determining the promotion point information as the highest priority among the usage priorities based on the comparison.

In the alternative embodiment of the method of managing points, the method may also be additionally implemented by: a module for calculating payment necessary information in which the use point amount by the payment point information is subtracted from the product value included in the payment information; a module for transmitting at least a part of payable information, which is matched with the user information based on the payment necessary information and stored, to the merchant server; a module for calculating finance server payment necessary information obtained by subtracting at least a part of the payable information transmitted to the merchant server from the payment necessary information; and a module for transmitting the finance server payment necessary information to at least one finance server among one or more finance servers.

In the alternative embodiment of the method of managing points, the method may also be additionally implemented by: a module for receiving the total amount of points obtained by summing the amount of points held by each user from one point server among the one or more point servers; a module for receiving deposit information on the point company based on the one point server from a bank server; and a module for determining whether to exclude the point information received from the one point server from the payment point information based on the total amount of points, the deposit information, and a predetermined deposit rate.

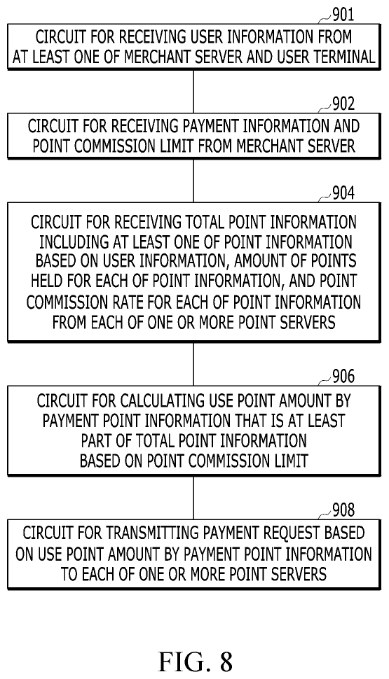

FIG. 8 is a block diagram illustrating a circuit for implementing a method of managing points according to an exemplary embodiment of the present disclosure.

According to an exemplary embodiment of the present disclosure, a method of managing points may be implemented by circuits described below.

According to the exemplary embodiment of the present disclosure, the method of managing points may be implemented by: a circuit 901 for receiving user information from at least one of a merchant server and a user terminal; a circuit 902 for receiving payment information and a point commission limit from the merchant server; a circuit 904 for receiving total point information including at least one of point information based on the user information, the amount of points held for each of the point information, and a point commission rate for each of the point information from each of one or more point servers; a circuit 906 for calculating a use point amount by payment point information that is at least a part of the total point information based on the point commission limit; and a circuit 908 for transmitting a payment request based on the use point amount by payment point information to each of the one or more point servers.

In the alternative embodiment of the method of managing points, the circuit 906 for calculating the use point amount by payment point information that is at least a part of the total point information based on the point commission limit may also be implemented by: a circuit for determining a usage priority of each of the point information based on at least one of the point commission rate for each of the point information and information on the point server for each of the point information; and a circuit for determining a use point amount by payment point information in the point information so that the total amount of point commission for each of the payment point information that is at least a part of the total point information is equal to or less than the point commission limit based on the usage priority, and the total amount of use points for each of the payment point information that is at least a part of the total point information is equal to or less than a product value included in the payment information based on the usage priority.

In the alternative embodiment of the method of managing points, the circuit 906 for calculating the use point amount by payment point information that is at least a part of the total point information based on the point commission limit may also be implemented by: a circuit for determining a usage priority of each of the point information based on a point commission rate for each of the point information for each of the point information; a circuit for determining the amount of point commission of each of the point information based on the amount of points held and the point commission rate for each of the point information, and calculating the total amount of point commission of each of the point information; a circuit for determining the entirety of the point information as usable point information when the total amount of point commission of each of the point information is equal to or less than the point commission limit; and a circuit for determining at least a part of the point information as the usable point information when the total amount of point commission of each of the point information is larger than the point commission limit.

In the alternative embodiment of the method of managing points, the circuit for determining at least a part of the point information as the usable point information when the total amount of point commission of each of the point information is larger than the point commission limit may also be implemented by a circuit for making an adjustment so that the total amount of point commission is equal to or less than the point commission limit by subtracting at least a part of the amount of point commission for the point information having a low priority among the usage priorities of the respective point information from the total amount of point commission.

In the alternative embodiment of the method of managing points, the method may also be additionally implemented by: a circuit for calculating the total amount of use points for each of the usable point information; a circuit for determining the usable point information as the payment point information when the total amount of use points for each of the usable point information is equal to or less than a product value included in the payment information; and a circuit for determining at least a part of the usable point information as the payment point information when the total amount of use points for each of the usable point information is larger than the product value.

In the alternative embodiment of the method of managing points, the circuit for determining at least a part of the usable point information as the payment point information may also be additionally implemented by a circuit for making an adjustment so that the total amount of use points is equal to or less than the product value by subtracting at least a part of the amount of use points for the usable point information having a low priority among the usage priorities of the respective usable point information from the total amount of use points.

In the alternative embodiment of the method of managing points, the method may also be additionally implemented by: a circuit for transmitting the amount of points based on the payment point information to at least one of a user terminal and the merchant server; a circuit for receiving a use authorization for at least a part of the amount of points based on the payment point information from at least one of the user terminal and the merchant server; and a circuit for calculating a use point amount by payment point information by adjusting the amount of points based on the payment point information on the basis of the use authorization and the usage priority.

In the alternative embodiment of the method of managing points, the method may also be additionally implemented by a circuit for receiving at least one of a priority usable condition and an unusable condition for at least a part of the total point information from the user terminal, and the circuit 906 for calculating the use point amount by payment point information that is at least a part of the total point information based on the point commission limit may also be implemented by: a circuit for excluding the point information corresponding to the unusable condition from the payment point information; a circuit for determining the point information corresponding to the priority usable condition as the prior usage priority over the usage priority of each of the remaining point information, in which the point information corresponding to the priority usable condition is excluded from the total point information; and a circuit for determining the usage priority of each of the point information based on the point commission rate for each of the point information for each of the point information except for at least one of the point information corresponding to the unusable condition and the point information corresponding to the priority usable condition in the total point information.

In the alternative embodiment of the method of managing points, the method may also be additionally implemented by: a circuit for receiving a point information use authority based on another user information from the user terminal; and a circuit for receiving the amount of points held for each of the point information based on another user information and the point commission rate for each of the point information based on another user information from each of one or more point servers.

In the alternative embodiment of the method of managing points, the method may also be additionally implemented by a circuit for receiving an alternative payment point from the user terminal, and the circuit 906 for calculating the use point amount by payment point information in the point information based on the point commission limit may also be implemented by the circuit for determining the alternative payment point as the usage priority.

In the alternative embodiment of the method of managing points, the method may also be additionally implemented by: a circuit for identifying at least one among restriction conditions for the point information included in at least one of the point information and the payment information; and a circuit for excluding the point information identified based on the restriction condition in the total point information from the payment point information.

In the alternative embodiment of the method of managing points, the method may also be additionally implemented by a circuit for, when one point server among the one or more point servers is the same as the merchant server, excluding the point information received from the same point server as the merchant server from the payment point information.

In the alternative embodiment of the method of managing points, the method may also be additionally implemented by: a circuit for receiving restriction information on one point server among the one or more point servers from the merchant server; and a circuit for excluding the point information received from the point server identified based on the restriction information from the payment point information.

In the alternative embodiment of the method of managing points, the method may also be additionally implemented by: a circuit for receiving restriction information on one point server among the one or more point servers from the merchant server; and a circuit for excluding the point information received from the point server identified based on the restriction information from the payment point information.

In the alternative embodiment of the method of managing points, the method may further include: a circuit for receiving promotion point information including at least one of user information restriction, merchant server information restriction, and purchase information restriction from at least one point server among the one or more point servers; and a circuit for comparing the restriction included in the promotion point information with at least one of the user information, the merchant server, and the purchase information, and the method may also be implemented by at least one of a circuit for matching the promotion point information to the user information based on the comparison and storing the matched promotion point information when a payment is completed; and a circuit for determining the promotion point information as the highest priority among the usage priorities based on the comparison.

In the alternative embodiment of the method of managing points, the method may also be additionally implemented by: a circuit for calculating payment necessary information in which the use point amount by the payment point information is subtracted from the product value included in the payment information; a circuit for transmitting at least a part of payable information, which is matched with the user information based on the payment necessary information and stored, to the merchant server; a circuit for calculating finance server payment necessary information obtained by subtracting at least a part of the payable information transmitted to the merchant server from the payment necessary information; and a circuit for transmitting the finance server payment necessary information to at least one finance server among one or more finance servers.

In the alternative embodiment of the method of managing points, the method may also be additionally implemented by: a circuit for receiving the total amount of points obtained by summing the amount of points held by each user from one point server among the one or more point servers; a circuit for receiving deposit information on the point company based on the one point server from a bank server; and a circuit for determining whether to exclude the point information received from the one point server from the payment point information based on the total amount of points, the deposit information, and a predetermined deposit rate.

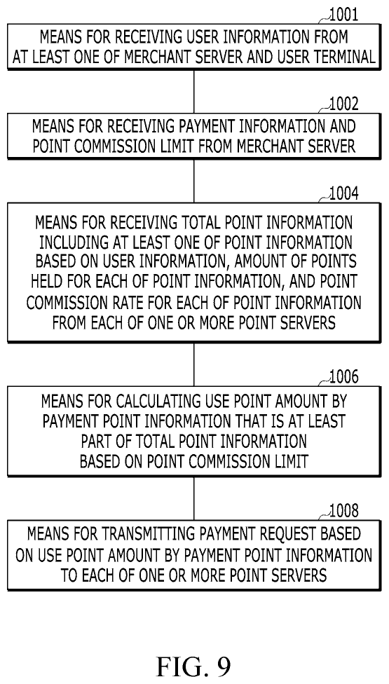

FIG. 9 is a block diagram illustrating a means for implementing a method of managing points according to an exemplary embodiment of the present disclosure.

According to an exemplary embodiment of the present disclosure, a method of managing points may be implemented by means described below.

According to the exemplary embodiment of the present disclosure, the method of managing points may be implemented by: a module 1001 for receiving user information from at least one of a merchant server and a user terminal; a means 1002 for receiving payment information and a point commission limit from the merchant server; a means 1004 for receiving total point information including at least one of point information based on the user information, the amount of points held for each of the point information, and a point commission rate for each of the point information from each of one or more point servers; a means 1006 for calculating a use point amount by payment point information that is at least a part of the total point information based on the point commission limit; and a means 1008 for transmitting a payment request based on the use point amount by payment point information to each of the one or more point servers.

In the alternative embodiment of the method of managing points, the means 1006 for calculating the use point amount by payment point information that is at least a part of the total point information based on the point commission limit may also be implemented by: a means for determining a usage priority of each of the point information based on at least one of the point commission rate for each of the point information and information on the point server for each of the point information; and a means for determining a use point amount by payment point information in the point information so that the total amount of point commission for each of the payment point information that is at least a part of the total point information is equal to or less than the point commission limit based on the usage priority, and the total amount of use points for each of the payment point information that is at least a part of the total point information is equal to or less than a product value included in the payment information based on the usage priority.

In the alternative embodiment of the method of managing points, the means 1006 for calculating the use point amount by payment point information that is at least a part of the total point information based on the point commission limit may also be implemented by: a means for determining a usage priority of each of the point information based on a point commission rate for each of the point information for each of the point information; a means for determining the amount of point commission of each of the point information based on the amount of points held and the point commission rate for each of the point information, and calculating the total amount of point commission of each of the point information; a means for determining the entirety of the point information as usable point information when the total amount of point commission of each of the point information is equal to or less than the point commission limit; and a means for determining at least a part of the point information as the usable point information when the total amount of point commission of each of the point information is larger than the point commission limit.

In the alternative embodiment of the method of managing points, the means for determining at least a part of the point information as the usable point information when the total amount of point commission of each of the point information is larger than the point commission limit may also be implemented by a means for making an adjustment so that the total amount of point commission is equal to or less than the point commission limit by subtracting at least a part of the amount of point commission for the point information having a low priority among the usage priorities of the respective point information from the total amount of point commission.

In the alternative embodiment of the method of managing points, the method may also be additionally implemented by: a means for calculating the total amount of use points for each of the usable point information; a means for determining the usable point information as the payment point information when the total amount of use points for each of the usable point information is equal to or less than a product value included in the payment information; and a means for determining at least a part of the usable point information as the payment point information when the total amount of use points for each of the usable point information is larger than the product value.

In the alternative embodiment of the method of managing points, the means for determining at least a part of the usable point information as the payment point information may also be implemented by a means for making an adjustment so that the total amount of use points is equal to or less than the product value by subtracting at least a part of the amount of use points for the usable point information having a low priority among the usage priorities of the respective usable point information from the total amount of use points.

In the alternative embodiment of the method of managing points, the method may also be additionally implemented by: a means for transmitting the amount of points based on the payment point information to at least one of a user terminal and the merchant server; a means for receiving a use authorization for at least a part of the amount of points based on the payment point information from at least one of the user terminal and the merchant server; and a means for calculating a use point amount by payment point information by adjusting the amount of points based on the payment point information on the basis of the use authorization and the usage priority.

In the alternative embodiment of the method of managing points, the method may also be additionally implemented by a means for receiving at least one of a priority usable condition and an unusable condition for at least a part of the total point information from the user terminal, and the means 1006 for calculating the use point amount by payment point information that is at least a part of the total point information based on the point commission limit may also be implemented by: a means for excluding the point information corresponding to the unusable condition from the payment point information; a means for determining the point information corresponding to the priority usable condition as the prior usage priority over the usage priority of each of the remaining point information, in which the point information corresponding to the priority usable condition is excluded from the total point information; and a means for determining the usage priority of each of the point information based on the point commission rate for each of the point information for each of the point information except for at least one of the point information corresponding to the unusable condition and the point information corresponding to the priority usable condition in the total point information.

In the alternative embodiment of the method of managing points, the method may also be additionally implemented by: a means for receiving a point information use authority based on another user information from the user terminal; and a means for receiving the amount of points held for each of the point information based on another user information and the point commission rate for each of the point information based on another user information from each of one or more point servers.

In the alternative embodiment of the method of managing points, the method may also be additionally implemented by a means for receiving an alternative payment point from the user terminal, and the means 1006 for calculating the use point amount by payment point information in the point information based on the point commission limit may also be implemented by the means for determining the alternative payment point as the usage priority.

In the alternative embodiment of the method of managing points, the method may also be additionally implemented by: a means for identifying at least one among restriction conditions for the point information included in at least one of the point information and the payment information; and a means for excluding the point information identified based on the restriction condition in the total point information from the payment point information.

In the alternative embodiment of the method of managing points, the method may also be additionally implemented by a means for, when one point server among the one or more point servers is the same as the merchant server, excluding the point information received from the same point server as the merchant server from the payment point information.

In the alternative embodiment of the method of managing points, the method may also be additionally implemented by: a means for receiving restriction information on one point server among the one or more point servers from the merchant server; and a means for excluding the point information received from the point server identified based on the restriction information from the payment point information.

In the alternative embodiment of the method of managing points, the method may also be additionally implemented by: a means for receiving restriction information on one point server among the one or more point servers from the merchant server; and a means for excluding the point information received from the point server identified based on the restriction information from the payment point information.

In the alternative embodiment of the method of managing points, the method may further include: a means for receiving promotion point information including at least one of user information restriction, merchant server information restriction, and purchase information restriction from at least one point server among the one or more point servers; and a means for comparing the restriction included in the promotion point information with at least one of the user information, the merchant server, and the purchase information, and the method may also be implemented by at least one of a means for matching the promotion point information to the user information based on the comparison and storing the matched promotion point information when a payment is completed; and a means for determining the promotion point information as the highest priority among the usage priorities based on the comparison.

In the alternative embodiment of the method of managing points, the method may also be additionally implemented by: a means for calculating payment necessary information in which the use point amount by the payment point information is subtracted from the product value included in the payment information; a means for transmitting at least a part of payable information, which is matched with the user information based on the payment necessary information and stored, to the merchant server; a means for calculating finance server payment necessary information obtained by subtracting at least a part of the payable information transmitted to the merchant server from the payment necessary information; and a means for transmitting the finance server payment necessary information to at least one finance server among one or more finance servers.

In the alternative embodiment of the method of managing points, the method may also be additionally implemented by: a means for receiving the total amount of points obtained by summing the amount of points held by each user from one point server among the one or more point servers; a means for receiving deposit information on the point company based on the one point server from a bank server; and a means for determining whether to exclude the point information received from the one point server from the payment point information based on the total amount of points, the deposit information, and a predetermined deposit rate.

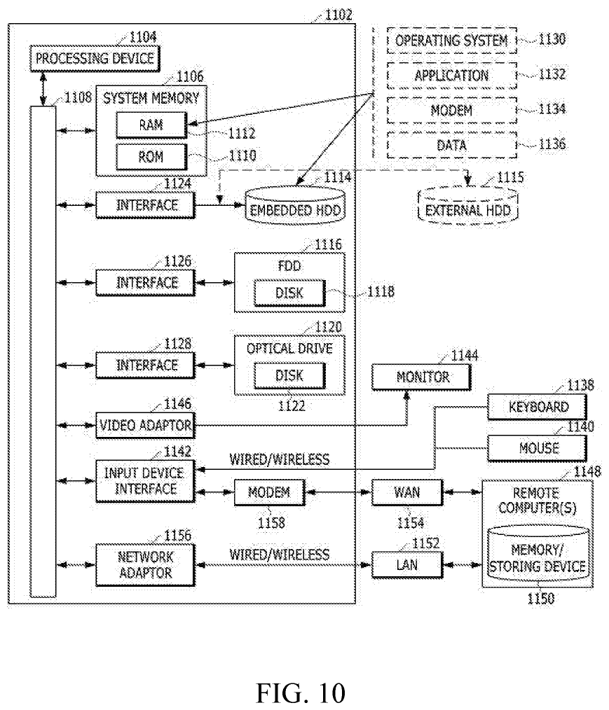

FIG. 10 is a block diagram of a computing device according to an exemplary embodiment of the present disclosure.

FIG. 10 is a simple and general schematic diagram of an illustrative computing environment, in which the exemplary embodiments of the present disclosure may be implemented.

The present disclosure has been generally described in relation to a computer executable command executable in one or more computers, but those skilled in the art will appreciate well that the present disclosure may be implemented in combination with other program modules and/or in a combination of hardware and software.

In general, a program module includes a routine, a program, a component, a data structure, and the like performing a specific task or implementing a specific abstract data type. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be positioned in both a local memory storage device and a remote memory storage device.

The computer generally includes various computer readable media. A computer accessible medium may be a computer readable medium regardless of the kind of medium. The computer readable medium includes volatile and non-volatile media and transitory and non-transitory media, and portable and non-portable media. As a non-limited example, the computer readable medium may include a computer readable storage medium and a computer readable transport medium. The computer readable storage medium includes volatile and non-volatile media, transitory and non-non-transitory media, portable and non-portable media constructed by a predetermined method or technology, which stores information, such as a computer readable command, a data structure, a program module, or other data. The computer readable storage medium includes a read only memory (RAM), a read only memory (ROM), electrically erasable and programmable ROM (EEPROM), a flash memory, or other memory technologies, a compact disc (CD)-ROM, a digital video disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally includes all of the information transport media, such as a carrier wave or other transport mechanisms, which implement a computer readable command, a data structure, a program module, or other data in a modulated data signal. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, radio frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various common processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routine helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of predetermined data in an appropriate digital form. In the description of the computer readable storage media, the HDD, the portable magnetic disk, and the portable optical media, such as a CD, or a DVD, are mentioned, but those skilled in the art will appreciate well that other types of compute readable storage media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be appreciated well that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display device are also connected to the system bus 1108 through an interface, such as a video adapter 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a workstation, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, Internet.

When the computer 1102 is used in the LAN networking environment, the computer 1102 is connected to the local network 1152 through a wired and/or wireless communication network interface or an adapter 1156. The adapter 1156 may make wired or wireless communication to the LAN 1152 easy, and the LAN 1152 also includes a wireless access point installed therein for the communication with the wireless adapter 1156. When the computer 1102 is used in the WAN networking environment, the computer 1102 may include a modem 1158, is connected to a communication computing device on a WAN 1154, or includes other means setting communication through the WAN 1154 via the Internet and the like. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, electric fields or particles, optical fields or particles, or a predetermined combination thereof

Those skilled in the art will appreciate that the various illustrative logical blocks, modules, processors, means, circuits, and algorithm operations described in relation to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable device. For example, the computer-readable medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be re-arranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

What is claimed is:

1. A non-transitory computer readable medium storing a computer program, wherein when the computer program is executed by one or more processors of a computing device, the computer program performs procedures for managing points, and the procedures include:
receiving, from at least one of a merchant server or a user terminal, user information;
receiving, from the merchant server, a point commission limit information and a payment information including the value excluding point payment value by at least one of an affiliate's points or a merchants' own points from a product value;
receiving, from each of one or more point servers, total point information including at least one of point information based on the user information, an amount of points held for each of the point information or a point commission rate for each of the point information;
calculating an amount of use points by payment point information that is at least a part of the total point information, based on the point commission limit information; and
transmitting, to each of the one or more point servers, a payment request based on the amount of use points by payment point information.

2. The non-transitory computer readable medium according to claim 1, wherein the point commission limit information includes a limit of a total amount of point commission for use of points to be paid to point companies set by a merchant.

3. The non-transitory computer readable medium according to claim 1, wherein the calculating an amount of use points by payment point information that is at least a part of the total point information based on the point commission limit information includes:
determining usage priority of each of the point information based on at least one of the point commission rate for each of the point information or information of the point server for each of the point information; and
determining an amount of use points by payment point information among the point information such that a total amount of point commission for each of a payment point information is equal to or less than the point commission limit information, and a total amount of use points for each of the payment point information is equal to or less than a product value included in the payment information, wherein the payment point information is at least a part of the total point information based on the usage priority.

4. The non-transitory computer readable medium according to claim 3, wherein the amount of point commission is a value obtained by multiplying at least part of the amount of points held by the point information with the point commission rate by the point information, and
wherein the amount of use points is at least a part of an amount of points held based on the amount of point commission by the point information.

5. The non-transitory computer readable medium according to claim 1, wherein the calculating an amount of use points by payment point information that is at least a part of the total point information based on the point commission limit information includes:
determining a usage priority of each of the point information based on the point commission rate by the point information, with respect to each of the point information;
determining an amount of point commission of each point information based on the amount of points held and the point commission rate for each point information;
calculating a total amount of point commission of each point information;
determining all of the point information as usable point information, if the total amount of point commission for each of the point information is equal to or less than the point commission limit information; and
determining at least part of the point information as usable point information, if the total amount of point commission for each of the point information exceeds the point commission limit information.

6. The non-transitory computer readable medium according to claim 5, wherein the determining at least part of the point information as usable point information, if the total amount of point commission for each of the point information exceeds the point commission limit information includes:
adjusting the total amount of point commission to be equal or less than the point commission limit information, by subtracting at least part of an amount of point commission for point information having a low usage priority among the usage priority of each of the point information from the total amount of point commission.

7. The non-transitory computer readable medium according to claim 5, wherein the procedures further include:
calculating a total amount of use points for each of the usable point information;
determining the usable point information as the payment point information, if the total amount of use points for each of the usable point information is equal to or less than a product value included in the payment information; and
determining at least part of the usable point information as the payment point information, if the total amount of use points for each of the usable point information exceeds the product value.

8. The non-transitory computer readable medium according to claim 7, wherein the determining the usable point information as the payment point information includes:
adjusting the total amount of use points to be equal to or less than the product value, by subtracting at least part of an amount of use points for usable point information having a low usage priority among the usage priority of each of the usable point information from the total amount of use points.

9. The non-transitory computer readable medium according to claim 7, wherein the procedures further include:
transmitting, to at least one of the user terminal or the merchant server, an amount of points based on the payment point information;
receiving, from at least one of the user terminal or the merchant server, a use authorization for at least part of the amount of points based on the payment point information; and
calculating an amount of use points for each of the payment point information, by adjusting an amount of points based on the payment point information, based on the use authorization and the usage priority.

10. The non-transitory computer readable medium according to claim 1, wherein the procedures further include receiving, from the user terminal, at least one of a priority usable condition or an unusable condition for at least part of the total point information, and
wherein the calculating an amount of use points by payment point information that is at least a part of the total point information based on the point commission limit information includes:
excluding point information corresponding to the unusable condition from the payment point information;
determining a usage priority of a point information corresponding to the priority usable condition as a higher usage priority than each of a remaining point information except for the point information corresponding to the priority usable condition among the total point information; and
determining a usage priority based on point commission rate by the point information for each point information except for point information corresponding to at least one of point information corresponding to the unusable condition or point information corresponding to the priority usable condition among the total point information.

11. The non-transitory computer readable medium according to claim 1, wherein the procedures further include:
receiving, from the user terminal, point information use authority based on another user information; and
receiving, from each of one or more point servers, an amount of points held by point information based on the other user information and point commission rate by the point information based on the other user information.

12. The non-transitory computer readable medium according to claim 1,
wherein the procedures further include receiving an alternative payment point information from the user terminal, and
wherein the calculating an amount of use points by payment point information that is at least a part of the total point information based on the point commission limit information includes determining the alternative payment point information as a highest priority among usage priorities.

13. The non-transitory computer readable medium according to claim 1, wherein the procedures further include:
identifying a restriction condition for point information included in at least one of the point information or the payment information; and
excluding point information identified based on the restriction condition among the total point information from payment point information.

14. The non-transitory computer readable medium according to claim 1, wherein the procedures further include excluding point information received from a same point server as the merchant server from the payment point information, if one point server among the one or more point servers is the same or corresponding server as the merchant server.

15. The non-transitory computer readable medium according to claim 1, wherein the procedures further include:
receiving, from the merchant server, restriction information for one point server among the one or more point servers; and
excluding point information received from the point server identified based on the restriction information from the payment point information.

16. The non-transitory computer readable medium according to claim 1, wherein the procedures further include:
receiving, from one point server among the one or more point servers, a total amount of points which is the sum of amounts of points held by each user;
receiving, from a bank server, a deposit information for a point company based on the one point server; and
determining whether to exclude point information received from the one point server from payment point information, based on the total amount of points, the deposit information and a predetermined deposit ratio.

17. The non-transitory computer readable medium according to claim 1, wherein the procedures further include:
receiving, from one point server among the one or more point servers, a promotion point information including at least one of a user information restriction, a merchant information restriction or a purchase information restriction; and
comparing a restriction included in the promotion point information with at least one of the user information, merchant information or purchase information, and
wherein the procedures further include at least one of:
storing the promotion point information by matching the user information based on the comparison, if the payment is completed; or
determining the promotion point information as the highest priority among usage priorities based on the comparison.

18. The non-transitory computer readable medium according to claim 1, wherein the procedures further include:
calculating a payment necessary information by subtracting an amount of use points for each of the payment point information from a product value included in the payment information;
transmitting, to the merchant server, at least a part of a payable information stored in match with the user information based on the payment necessary information;
calculating financial server payment necessary information by subtracting at least a part of the payable information which is transmitted to the merchant server, from the payment necessary information; and
transmitting, to at least one financial server among one or more financial servers, the financial server payment necessary information.

19. A method for managing points comprising:
receiving, from at least one of a merchant server or a user terminal, user information;
receiving, from the merchant server, a point commission limit information and a payment information including the value excluding point payment value by at least one of an affiliate's points or a merchants' own points from a product value;
receiving, from each of one or more point servers, total point information including at least one of point information based on the user information, an amount of points held for each of the point information or a point commission rate for each of the point information;
calculating an amount of use points by payment point information that is at least a part of the total point information, based on the point commission limit information; and
transmitting, to each of the one or more point servers, a payment request based on the amount of use points by payment point information.

20. A server for managing points, comprising:
a processor including one or more cores; and
a memory;
wherein the processor is configured to
receive, from at least one of a merchant server or a user terminal, user information;
receive, from the merchant server, a point commission limit information and a payment information including the value excluding point payment value by at least one of an affiliate's points or a merchants' own points from a product value;
receive, from each of one or more point servers, total point information including at least one of point information based on the user information, an amount of points held for each of the point information or a point commission rate for each of the point information;
calculate an amount of use points by payment point information that is at least a part of the total point information, based on the point commission limit information; and
transmit, to each of the one or more point servers, a payment request based on the amount of use points by payment point information.
